(19) United States
(12) Patent Application Publication
(10) Pub. No.: US 2010/0291230 A1
(43) Pub. Date: Nov. 18, 2010

(54) Novel Pesticide Compositions

(75) Inventors: Meneachem Assaraf, LeHavim (IL); Ron Frim, Haifa (IL)

Correspondence Address: MARTIN D. MOYNIHAN d/b/a PRTSI, INC., P.O. BOX 16446, ARLINGTON, VA, 22215, US

(73) Assignee: Bromine Compounds Ltd., Beer-Sheva (IL)

(21) Appl. No.: 12/223,179

(22) PCT Filed: Jan. 8, 2007
(86) PCT No.: PCT/IL07/00018

§ 371 Date: Jul. 21, 2010

Related U.S. Application Data
(60) Provisional application No. 60/761,329, filed on Jan. 24, 2006.

(51) Int. Cl. A01N 59/26; A01P 5/00; A01P 3/00; A01P 1/00

(52) U.S. Cl. 424/605

(57) ABSTRACT

Novel pesticide compositions and formulations, containing a phosphorous-containing compound and a nitrogen-releasing compound, are disclosed. These novel compositions exhibit a synergistic pesticidal activity and are particularly useful in treating pests such as nematodes (including root-not nematodes), fungi and bacteria. Methods utilizing these compositions for controlling pests, articles-of-manufacture containing same and processes of preparing same are further disclosed.

### FIELD AND BACKGROUND OF THE INVENTION

The present invention relates to the field of pesticides and, more particularly, to novel compositions that exhibit synergistic activity in controlling growth of pests such as nematodes.

Pests are a collective term used to describe parasitic organisms and include, for example, fungi, insects, nematodes, rodents and the like. “Pesticides” is therefore a collective term used to describe compounds, compositions and formulations that are used to at least reduce populations and/or growth and preferably destroy pest/s. Pesticides are widely and advantageously used in agriculture, to control pests and to prevent plant diseases. The use of pesticides in agriculture however is oftentimes limited by insufficient selectivity of their toxicity, which may thus affect also humans, animals, and useful plants, and by relatively slow degradation and dissipation of the active chemicals. In addition, pest species may develop resistance to the pesticide over time.

Nematodes are plant parasites that pose one of the most serious economical damage in agriculture. Nematodes are roundworms comprising as many as 10,000 species, of which at least 150 are known to adversely affect plant life. Plant parasitic nematodes have been known since about 1750. Most of the nematodes which cause crop damage do so by feeding on plant roots, and therefore are found primarily in the upper soil layer, in the roots or in the rhyzosphere (close proximity to the roots). Nematode feeding causes hyperplasia and hypertrophy or gall formation in the roots. The observed symptoms of heavy infestation are plant stunting, yellowing, pale foliage, wilting, and even plant death in extreme cases.

Nematodes usually act by first invading the root, and then moving along plant vascular tissues until a suitable feeding site is found. It has been shown that some nematodes also induce specialized feeding sites in their hosts, which provide the nematodes with greatly increased amounts of nutrition sources, enabling them to have high rates of reproduction and, consequently, become even more serious crop pests. The nematodes induce these changes by injecting, through their hollow stylet, secretions from oesophageal gland cells into the root cells around their heads. These cells become enlarged and much more active and are termed “Giant Cells” (Trudgill, D. L., “Management of plant parasitic nematodes”, The 1999/00 Scottish Crop Research Institute (SCRI) Annual Report.). The Giant Cell acts by accumulating plant photosynthetic product and nutrients, and by transferring these nutrients from the plant cell to the nematode via the nematodes feeding tube. This phenomenon leads to poor nutrition of the plant (“the nematode problem”, in http://www.biology.leeds.ac.uk/nem/overview/problem.htm).

Parasitic nematodes can virtually attack all of the world's crops and ornamental plants. Important destructive nematode species include the root knot nematodes which are hosted by tomatoes, pepper, cucumber, alfalfa, cotton, corn, potatoes, citrus and many other crops, the golden nematode of potatoes, the sugar beet cyst nematode, and the citrus nematode. Nematode infestation may further result in a reduced tolerance and/or a reduced resistance to the effects of plant attacks by bacteria and pathogenic soil fungi. For additional information in these respects see, “The Soil Pest Complex”, Agricultural and Food Chemistry, Vol. 3, pages 202-205 (1955), which is incorporated by reference as if fully set forth herein.

To date, an effective method for controlling and/or eliminating nematodes in large soil areas has not been found. Presently employed techniques include soil and/or plant treatment by various nematicides, which may keep parasite populations at levels which economically permit agricultural operations, crop rotation using non-hosting plant varieties, and (to a much lesser extent) the development of plants which are resistant to nematode attack. In many instances, control of nematodes is achieved only by combinations of these techniques, and hence most control programs are costly.

The presently known chemical nematicides are classified, based on the volatility thereof, as non-fumigants and fumigants.

Fumigant nematicides disperse through the soil as a result of their volatility and include two main groups of chemicals: halogenated hydrocarbons and methyl isothiocyanate (MITC) releasing compounds.

Common halogenated hydrocarbons include chloropicrin, methyl bromide, 1,3-dichloropropene, 1,2-dibromoethane, 3-bromopropyne, 1,2-dichloropropane, ethylene dichloride, methyl iodide and others, as well as mixtures thereof, all of which are characterized by relative phytotoxicity, and thus their utility is restricted mostly to pre-planting fumigation treatments. Some of these agents are further recognized as posing risks to the environment. Methyl bromide, the presently most used pre-plant soil fumigant, was banned and is undergoing a regulatory phase out.

Usable isothiocyanate releasing compounds include, for example, sodium methyl dithiocarbamate, potassium methyl dithiocarbamate, methyl isothiocyanate, basamid and sodium tetrathiocarbonate. The use of isothiocyanates, however, is limited by a narrow spectrum of target pest control, an inconsistent performance in various soils, possible microbial accelerated degradation following repeated use, and a dependence of the treatment success on a precise application method.

In addition, fumigation techniques are oftentimes incapable to tackle the rapid migration of nematodes from non-treated soil depths to the root zone, resulting in unavoidable root infection and crop loss.

The non-fumigant nematicides mainly consist of carbamates and organophosphates, as well as some alternative materials, such as some of the nitrogen-releasing compounds detailed below.

Carbamates are generally applied to the soil either through water or within various formulations. Some examples are aldicarb, carbofuran, oxamyl and aldoxycarb, which are all considered highly toxic and classified as Category pesticides.

Common examples of organophosphates that are used as non-fumigant nematicides include fensulfothion and ethoprop. However, the use of organophosphate nematicides is limited by insufficient efficacy, mainly due to the lack of control on nematodes which have penetrated the root tissues.

Phosphorus (P) is one of the essential elements for normal growth and development of plants. In fertilizers, it is normally found in the form of phosphoric acid (H₃PO₄), which readily disassociates to release hydrogen phosphate (HPO₄²⁻) and dihydrogen phosphate (H₂PO₄⁻). Both of these ions may be taken up by the plant but H₂PO₄⁻ more readily so. Once inside the plant, both ions are mobile.

An additional phosphorous-containing compound is phosphorous acid (H₃PO₃), which is also referred to in the art as phosphonic acid. Phosphonic acid dissociates to release the phosphonate ion (HPO₃⁻²), also called phosphite. Like phosphate, phosphonate is easily taken up and translocated inside the plant. To date, no plant enzymes have been described that could oxidize phosphonate into phosphate. As a result, the phosphonate ion is typically stable in plants and is not converted into phosphate [Smillie et al., 1989, Phytopathology 79:921-926].

Although phosphate is an excellent source of phosphor for plant growth, it typically serves to improve the general health of the crop and thereby improve its natural defense system. Nevertheless, phosphate ion is unable to control pathogen attack by Oomycetes.

Phosphorous acid has advantageous properties useful in agriculture: it has both a direct and an indirect effect on Oomycetes, inhibiting the oxidative phosphorylation process in the metabolism of Oomycetes [McGrath, M. T., 2004, The American Phytopatho logical Society, http://www.apsnet.org/education/IntroPlantPath/Topics/fungicides/pdfs/CommonAndTradeFungicides.pdf, last accessed: Dec. 12, 2005]. In addition, some-evidence suggests that phosphorous acid has an indirect effect by stimulating the plant's natural defense response against pathogen attack [Nutri-Phite Fertilizer: Biagro Western Sales, Inc., http://www.biagro.com/nutri_phite/np_html/np_content intro.html, last accessed: Dec. 12, 2005; Smillie et al., 1989 supra]. Recently, it was shown that phosphorous acid is effective when applied as a root drench against P. cinnamomi, P. nicotianae, and P. palmivora in lupin, tobacco, and papaya, respectively. WO 00/62619 also describes the use of phosphorous acid or salts thereof for killing nematodes and protecting plants. Insecticidal, acaricidal, and nematicidal organophosphoric acid esters are also described in U.S. Pat. No. 4,189,476 (to Saito et al.). U.S. Pat. No. 6,689,392, to the present assignee, teaches a nematicidal formulation comprising phosphorus acid in combination with metal ions and chelating agents.

However, although phosphorous acid controls Oomycetes in a number of host-parasite systems, it was found that some Oomycetes may develop resistance thereto [Ouimette and Coffey, 1989, Phytopathology 79:761-767]. For example, the existence of Phytophthora spp. resistant against phosphonate has been reported [Brown et al., 2004, Plant Dis. 88:502-508; Dolan and Coffey, 1988, Phytopathology 78:974-978; Fenn and Coffey, 1985, Phytopathology 75:1064-1068, Fenn and Coffey, 1989, Phytopathology 79:76-82; Griffith et al., 1993, J. Gen. Microbiol. 139:2109-2116; Nelson et al., 2004, Plant Health Progress. http://www.plantmanagementnetwork.org/sub/php/research/2004/aliette last accessed: Jan. 28, 2005; Ouimette and Coffey, 1989 supra]. Hence, care should be taken to alternate phosphonates with other effective compounds to prevent a buildup of resistant Phytophtora spp. in the field.

In addition, the use of phosphorus acid and derivatives thereof for controlling root-knot nematodes and other pests is further limited by high instability, and hence by poor efficacy as well as by adverse phytotoxic effects at the applied rates. Furthermore, phosphorous acid is not a substitute for phosphorus fertilization.

Nitrogen releasing compounds, such as urea, ClandoSan® (a mixture of chitin and urea) and DiTera® (a fungal metabolite) are also known as non-fumigant, post-plant nematicides. For example, the use of ammonia-releasing compounds for controlling the root-knot nematode Meloidogyne javanica is described in Oka and Pivonia [in Nematology, 2002. Vol. 4(1), p. 65-71]. Furthermore, Sinclair [in Plant Disease Rep, 1975 Vol. 59(4), pp. 334-336] discloses that the growth of plant-parasitic nematodes (such as Pratylenchus penetrans and Paratylenchus projectus) is suppressed by urea fertilization in a forest nursery.

However, low nitrogen uptake by the plant is a severe problem presently associated with agricultural crops. While nitrogen is a relatively expensive compound, crops have been found to recover only 30 to 70 percents of the total amount of the nitrogen (fertilizers) applied to the soil. Such a low uptake may be explained in view of the nitrogen cycle in soil and plants: urea, for example, is easily transformed in the soil to ammonia (NH₃), which in turn, is in equilibrium with ammonium ion (NH₄⁺). The ammonium ion may be further converted to nitrite (NO₂⁻) and nitrate ions (NO₃⁻), via a bacterially induced nitrification process. Both the ammonium and the nitrate ionic forms of nitrogen can be absorbed by the plant, with a major distinctive difference: the ammonium ion is fairly tightly bound by various physical and chemical processes in a soil environment and, thus it is less available to the plant. In contrast, the nitrate ion is fairly mobile in a soil environment and consequently, is easily taken up by plant roots and is also readily assimilated by plants. However, the increased mobility of the nitrite and nitrate ions renders them highly susceptible to loss by surface runoff and leaching from the plant root zone into deeper soil. Other losses of these ions are due to denitrification, which is reduction of nitrate to elemental nitrogen or gaseous nitrogen oxides under conditions of limited aeration. In addition to the direct economic losses, the nitrite and nitrate ionic forms of nitrogen constitute environmental pollutants when runoff enters surface and ground water systems.

Since ammonia or ammonium-producing compounds presently serve as main sources of agricultural nitrogen, maintenance of the applied nitrogen in the ammonium form should mean that less nitrogen is lost by denitrification. Thus, in this regard, the nitrification process is desirable. Unfortunately, the control of the rate at which conversion from ammonium to nitrite and nitrate occurs in the soil has not been easily obtained. Inhibition of the nitrification may render the applied nitrogen available to plants over a longer period of time, resulting in increased plant uptake of the nitrogen. One method by which nitrogen supplied by ammonium can be maintained involves the addition of a nitrification inhibitor. Various compositions have been offered as inhibitors of nitrification, including expensive organic materials such as 2-chloro-6-(trichloromethyl)-pyridine, 2-amino-4-chloro-6-methylpyrimidine, sulfathiazole, alkanolysulfathiazoles, and others.

Hence, while the severe damage caused to horticultural crops by nematodes and other pests has led to an ongoing search for effective compositions for controlling pests, the presently known pesticides and particularly nematicides are mostly characterized by undesired toxicity, insufficient efficacy, cost inefficiency and/or inconsistent performance, as is detailed hereinabove, and their use is therefore limited.

While conceiving the present invention, it was envisioned that compositions combining nitrogen-releasing compounds together with phosphorus-containing compounds could serve as an efficient yet inexpensive pesticide, which would combine the advantageous nematicide activity of phosphorous acid and the beneficial characteristics of nitrogen-releasing compounds and would simultaneously circumvent the limitations associated with the use of these compounds as pesticides.

U.S. Patent Application No. 20050166652, to Blount describes studies, conducted following previous work (taught in U.S. Pat. No. 5,788,915) which demonstrate the flame retardancy properties of an urea-melting condensation product, referred to therein as an ammonium polyamino carbamate. The studies described in U.S. Patent Application No. 20050166652 show that the hydrolyzed carbamate product, ammonium polyamino carbamate, either alone, or in combination with a phosphorus compound, may act as a foliar non-systemic fungicide, fertilizer and insecticide. The compositions taught in U.S. Patent Application No. 20050166652 are strictly described by the process of their preparation, which is mainly effected by first contacting, heating and reacting urea, an acidic salt forming compound and a basic salt forming compound, and then adding a filler and water. The heating is conducted at temperatures of at least 75° C., above which the components melt, often at around 100° C. and up to 120° C.

According to the teachings of U.S. Patent Application No. 20050166652, the process of preparing the carbamate/phosphorous acid compositions results in the formation of urea condensate products, including biuret, as byproducts. Biuret is a white, crystalline, nitrogenous substance, having the formula (NH₂CO)₂NH, which is typically formed through a heat-induced self-condensation reaction of urea, as depicted in scheme 1 below:

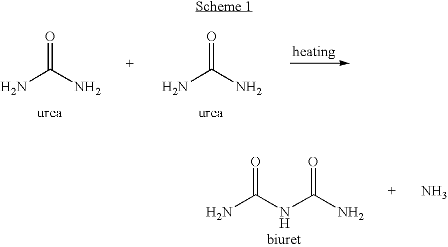

The existence of biuret, however, is known to adversely affect plants. Plants cannot metabolize biuret, and hence it is translocated and accumulated in leaves and apical tissues, thus causing injury to plants and reduced crop yields. Furthermore, it has been known that the biuret impurity in urea-based fertilizers is responsible for enhancing nitrite toxicity, by inhibiting the conversion of NH₄⁺ to NO₂⁻ and the subsequent oxidation of NO₂⁻ to NO_{3 -} in the soil [Mithyantha, M. S. et al., Fertilizer News, 1977, 22(3), p. 13-18]. These undesired side effects associated with the formation of biuret byproduct require that the urea heating stage should be as short as possible.

While U.S. Patent Application No. 20050166652 indeed mentions the need to shorten the urea heating stage, it is evident from its teachings that the compositions formed by the process described therein include urea condensates, such as the undesired biuret.

In addition, it is further clear from the teachings of U.S. Patent Application No. 20050166652 that the compositions produced by the process described therein are ineffective with regard to systemic treatment of plant diseases. Thus, in the Examples section of U.S. Patent Application No. 20050166652, the pesticidal effect of the compositions taught therein is demonstrated solely in the treatment of aphides on leaves, the treatment of cockroaches on the ground, and by foliar spraying against fungi. Accordingly, the effect of these compositions as pesticides against nematodes, which reside in the root area of the plants, is not demonstrated.

The process and resulting compositions taught in U.S. Patent Application No. 20050166652 therefore fail to address the need in compositions that would effectively exhibit systemic pesticidal, and particularly nematicidal, effect in plants and are further limited by their toxicity, which results from the presence of urea condensates such as biuret, formed in the process. There is thus a widely recognized need for, and it would be highly advantageous to have novel compositions for efficiently controlling nematodes, as well as other pests, devoid of the above limitations.

### SUMMARY OF THE INVENTION

According to one aspect of the present invention there is provided a pesticide composition comprising at least one phosphorous-containing compound selected from the group consisting of phosphorous acid, a salt thereof, a hydrate thereof and a solvate thereof, and at least one nitrogen-releasing compound.

According to another aspect of the present invention there is provided a nematicide composition comprising at least one phosphorous-containing compound selected from the group consisting of phosphorous acid, a salt thereof, a hydrate thereof and a solvate thereof, and at least one nitrogen-releasing compound.

According to further features in preferred embodiments of the invention described below, the nematicide composition described herein acts by inhibiting the development and/or growth of giant cells of a plant.

According to further features in preferred embodiments of the invention described below, the nitrogen-releasing compound is other than ammonia.

According to further features in preferred embodiments of the invention described below, the pesticidal and nematicidal compositions described herein, are capable of inducing systemic resistance in a plant.

According to further features in preferred embodiments of the invention, the phosphorous-containing compound(s) and the nitrogen-releasing compound(s) act in synergy.

According to further features in preferred embodiments of the invention described below, the amount of the phosphorous-containing compound(s) ranges from about 1 weight percentage to about 90 weight percentages of the total weight of the composition. Preferably, the amount of the phosphorous-containing compound(s) ranges from about 10 weight percentages to about 30 weight percentages of the total weight of the composition.

According to still further features in the described preferred embodiments, the amount of the nitrogen-releasing compound(s) ranges from about 1 weight percentage and about 90 weight percentages of the total weight of the composition, preferably, from about 10 weight percentage and about 25 weight percentages of the total weight of the composition.

According to still further features in the described preferred embodiments, the molar ratio between the phosphorous-containing compound(s) and the nitrogen-releasing compound(s) ranges from about 50:1 to about 1:50. According to still further features in the described preferred embodiments, the ratio preferably ranges from about 2:1 to about 1:2.

According to still further features in the described preferred embodiments, the phosphorous-containing compound is selected from the group consisting of H₃PO₃, K₂HPO₃, KH₂PO₃, Na₂HPO₃, NaH₂PO₃ and any mixture thereof.

According to still further features in the described preferred embodiments, the nitrogen-releasing compound is selected from the group consisting of urea, an amine-containing compound, a derivative thereof, a salt thereof and any mixture thereof.

According to still further features in the described preferred embodiments, the composition described herein is substantially devoid of a urea condensate.

According to still further features in the described preferred embodiments, the amine-containing compound comprises at least one amino acid. Preferably, the amino acid(s) are selected from the group consisting of cysteine, lysine and aspartic acid.

According to still further features in the described preferred embodiments, the amine-containing compound comprises a peptide

According to still further features in the described preferred embodiments, the composition further comprises at least one metal ion and optionally further comprises one or more chelating agent(s). Preferably, the metal ion is selected from the group consisting of a potassium ion, a copper ion, a zinc ion, a manganese ion, an aluminum ion and any mixture thereof. Further preferably, the amount of the metal ion ranges from about 1 weight percentage to about 10 weight percentages of the total weight of the composition.

According to still further features in the described preferred embodiments, the composition comprises:
from about 10 weight percentages to about 30 weight percentages of the phosphorous-containing compound; and
from about 10 weight percentages to about 25 weight percentages of the nitrogen-releasing compound.

Preferably, the nitrogen-releasing compound in this composition is urea, and the phosphorous-containing compound is H₃PO₃.

According to still further features in the described preferred embodiments, the compositions described herein are prepared by mixing the nitrogen-releasing compound, the phosphorous-containing compound and any other optional components, at room temperature in the presence of a solvent.

According to still further features in the described preferred embodiments, the compositions described hereinabove consist essentially of urea and H₃PO₃.

Preferably, the compositions consisting essentially of urea and H₃PO₃ are prepared by mixing, at room temperature, an aqueous solution of urea and H₃PO₃.

According to another aspect of the present invention there is provided a pesticide composition comprising at least one phosphorous-containing compound selected from the group consisting of phosphorous acid, a salt thereof, a hydrate thereof and a solvate thereof, and at least one nitrogen-releasing compound, wherein an amount of the at least one phosphorous-containing compound ranges from 10 weight percentage and about 30 weight percentages of the total weight of the composition and an amount of the at least one nitrogen-releasing compounds ranges from 10 weight percentage and about 25 weight percentages of the total weight of the composition.

According to another aspect of the present invention there is provided a pesticide formulation comprising any of the compositions described hereinabove, and a carrier.

According to further features in preferred embodiments of the invention described below, the carrier is selected from the group consisting of an aqueous carrier, an organic carrier and any combination thereof.

According to still further features in the described preferred embodiments, the formulation further comprises at least one agent selected from the group consisting of a protective colloid, an acidifying agent, an adhesive, a thickening agent, a penetrating agent, a stabilizing agent, a sequestering agent, a fertilizer, an anti-freeze agent, a repellent, a color additive, a corrosion inhibitor, a water-repelling agent, a siccative, a UV-stabilizer, a pigment, a dye and a polymer.

According to still further features in the described preferred embodiments, the concentration of the composition ranges from about 0.001 weight percentage to about 1 weight percentage of the total weight of the formulation.

According to still further features in the described preferred embodiments, the concentration of the composition preferably ranges from about 0.05 weight percentage to about 0.2 weight percentage of the total weight of the formulation.

According to still further features in the described preferred embodiments, the formulation is in the form of a solid, a powder, a solution, a dispersion, a suspension, a paste, an aerosol or a spray.

According to still further features in the described preferred embodiments, the formulation is packaged in a packaging material and is identified in print, in or on the material, for use in controlling pests.

According to still further features in the described preferred embodiments, the pests are selected from the group consisting of nematodes, fungi and bacteria.

According to still further features in the described preferred embodiments, the formulation further comprises at least one additional pesticide.

According to yet another aspect of the present invention there is provided a method of controlling pests, the method comprising contacting a substance, a product or a structure with a pesticidal effective amount of any of the compositions described herein.

According to further features in the described preferred embodiments, the substance is a soil.

According to still further features in the described preferred embodiments, the contacting is effected by spraying, drenching, soaking, dipping, mixing, coating, dispersing, injecting, irrigating or impregnating.

According to still further features in the described preferred embodiments, the method further comprises, prior to, concomitant with or subsequent to the contacting: disinfecting the substance, product or structure.

According to still further features in the described preferred embodiments, the disinfecting is performed prior to the contacting.

According to still further features in the described preferred embodiments, the composition described herein forms a part of a pesticide formulation, which further comprises a carrier.

According to still further features in the described preferred embodiments, the formulation is applied at an application rate ranging from about 1 liter/1000 m² to about 100 liters/1000 m². Preferably, the application rate ranges from about 1 liter/1000 m² to about 5 liters/1000 m².

According to still another aspect of the present invention there is provided an article-of-manufacture comprising a packaging material and any of the compositions described herein being packaged in the packaging material, the article-of-manufacture being identified for use in controlling pests.

According to further features in the described preferred embodiments, the composition in the article-of-manufacture described herein, forms a part of a pesticide formulation, this formulation further comprising a carrier.

According to yet another aspect of the present invention there is provided a process of preparing the pesticide composition described herein, which comprises mixing the phosphorous-containing compound and the nitrogen-releasing compound.

According to further features in the described preferred embodiments, in cases where the composition further comprises at least one metal ion and optionally at least one chelating agent, the process comprises mixing the phosphorous-containing compound, the nitrogen-releasing compound, the metal ion(s) and the chelating agent(s), if present.

According to still further features in the described preferred embodiments, the mixing is effected in the presence of a solvent. Preferably, the solvent is water. Further preferably, mixing is performed at room temperature.

The present invention successfully addresses the shortcomings of the presently known configurations by providing a novel pesticide composition which exhibits a synergistic pesticidal effect and is thus far superior to the presently practiced pesticides.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

As used herein, the term “treating” or “treatment” includes abrogating, substantially inhibiting, slowing or reversing the progression of a condition, substantially ameliorating clinical or aesthetical symptoms of a condition or substantially preventing the appearance of clinical or aesthetical symptoms of a condition.

As used herein, the term “comprising” means that other steps and ingredients that do not affect the final result can be added. This term encompasses the terms “consisting of” and “consisting essentially of”.

As used herein, the phrase “consisting essentially of” means that the composition or method may include additional ingredients and/or steps, but only if the additional ingredients and/or steps do not materially alter the basic and novel characteristics of the claimed composition or method.

As used herein, the terms “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “active ingredient” refers to a pesticidal agent including any natural or synthetic chemical compound that subsequent to its application has, at the very least, at least one desired pesticidal effect.

As used herein, the singular form “a,” “an,” and “the” include plural references unless the context clearly dictates otherwise. For example, the term “a compound” or “at least one compound” may include a plurality of compounds, including mixtures thereof.

Herein, the term “about” refers to ±10%.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 presents images demonstrating the phytotoxic effects of various concentrations of an exemplary urea-phosphite nematicide formulation (denoted UP), according to preferred embodiments of the present invention, on tomato transplants.

FIGS. 2(A-D) are bar graphs presenting the effect of various concentrations of an exemplary urea-phosphite formulation (denoted UP), according to preferred embodiments of the present invention, compared with non-treated control (denoted CK), on plant height (FIG. 2A), above-ground plant fresh weight (FIG. 2B), above-ground plant dry weight (FIG. 2C) and on the galling index (FIG. 2D) of tomato plants infected with root-knot nematodes (blue bars) and non-infected tomato plants (red bars);

FIGS. 3(A-C) are bar graphs presenting the effect of various concentrations of an exemplary urea-phosphite formulation (denoted UP), according to preferred embodiments of the present invention, compared with non-treated control (denoted CK), on above-ground plant fresh weight (FIG. 3A) and above-ground plant dry weight (FIG. 3B), and on the galling index (FIG. 3C) of tomato plants infected with root-knot nematodes (blue bars) and of non-infected tomato plants (red bars);

FIGS. 4(A-C) are bar graphs presenting the effect of various concentrations of an exemplary urea-phosphite formulation (denoted UP) according to preferred embodiments of the present invention, and of Canon® (a 50% phosphorous acid formulation), compared with non-treated control (denoted CK), on above-ground plant fresh weight (FIG. 4A) and above-ground plant dry weight (FIG. 4B), and on the galling index (FIG. 4C) of tomato plants infected with root-knot nematodes (blue bars) and of non-infected tomato plants (red bars);

FIGS. 5(A-D) are bar graphs presenting the effect of various concentrations of an exemplary urea-phosphite formulation (denoted UP), according to preferred embodiments of the present invention, and of Canon® (a 50% phosphorous acid formulation) and Vidate® (methyl 2-(dimethylamino)-N-[[methylamino)carbonyl]oxy]-2-oxoethanimidothioate, also known as oxamyl), a commercial post-plant nematicide), compared with non-treated and non-infected control (denoted CK), and non-treated and nematode-infected control (denoted CK+N), on the above-ground plant fresh weight (FIGS. 5A and 5C, and galling index (FIGS. 5B and 5D) of Hyperikum plants, infected with root-knot nematodes, and grown in soil (FIGS. 5A and 5B) and in artificial substrate (perlite, FIGS. 5C and 5D);

FIGS. 6(A-C) are bar graphs presenting the effect of various formulations, (urea phosphite formulations (denoted UP) containing variable molar ratios of its components (1:1, 1:2 urea:phsophite, 2:1 urea:phsophite), an urea formulation and Canon® (a 50% phosphorous acid formulation) applied in a 0.1% concentration, compared with a non-treated control (denoted CK), on the galling incidence (FIG. 6A), the galling index (FIG. 6B) and the dry weight (FIG. 6C) of tomato plants infected with root-knot nematodes;

FIGS. 7(A-C) are bar graphs presenting the effect of 0.1% formulations containing a 1:1 molar ratio of urea-phosphite (denoted UP), a 1:1 molar ratio of triethylamine-phosphite (denoted AP), triethylamine (denoted Amine), urea and phosphite, compared with non-treated control (denoted CK) on the galling incidence (FIG. 7A), the galling index (FIG. 7B) and dry weight, (FIG. 7C) of tomato plants infected with root-knot nematodes;

FIGS. 8(A-B) are bar graphs presenting the effect of 0.1% formulations of Canon® (a 50% phosphorous acid formulation), Comin, Vidate® and various nitrogen-releasing compounds either alone or in combination with phosphite (denoted “+P”), compared with non-treated control (denoted CK), on the galling index (FIG. 8A) and the dry weight (FIG. 8B) of tomato plants infected with root-knot nematodes;

FIGS. 9(A-B) are bar graphs presenting the effect of various concentrations of an exemplary Urea-Phosphite formulation (denoted UP), according to preferred embodiments of the present invention, compared with similar concentrations of Canon® (a 50% phosphorous acid commercial formulation) and with non-treated control (denoted CK), on the galling incidence (FIG. 9A, green, blue and red bars represent disease index of 2, 3 and 4, respectively) and disease index (FIG. 9B) of roots of snap dragon (Antirrhinum majus) grown in a field infested with root-knot nematodes;

FIG. 10 is a bar graph presenting the effect of pre-plant soil disinfestation with Methyl Bromide (denoted MB), Condor® (a commercial nematicide fumigant comprising dichloropropene) and Telodrip® (a commercial multi-purpose liquid fumigant, comprising dichloropropene (61%) and chloropicrin (34.7%)), alone or in combination with post-plant application of an exemplary urea-phosphite formulation (denoted UP) according to the present embodiments, compared with a non-treated control (denoted CK) and a control treated only with UP (denoted CK+UP) on damping-off disease of snap dragon (Antirrhinum majus) grown in a field infested with root-knot nematodes (measured as the cumulative values of dead plants taken at two separate dates);

FIG. 11 is a bar graph presenting the effect of pre-plant soil disinfestation with Methyl Bromide (denoted MB), Condor® and Telodrip®, alone or in combination with post-plant application of an exemplary urea-phosphite formulation (denoted UP) according to the present embodiments, compared with a non-treated control (denoted CK) and a control treated only with UP (denoted CK+UP) on the yield of flower stems of snap dragon (Antirrhinum majus) grown in a field infested with root-knot nematodes in a first (brown), second (blue) and third (red) harvest cycles;

FIGS. 12(A-B) are bar graphs presenting the effect of pre-plant soil disinfestation with Methyl Bromide (denoted MB), Condor® and Telodrip®, alone or in combination with post-plant application of an exemplary urea-phosphite formulation (denoted UP) according to the present embodiments, compared with a non-treated control (denoted CK) and a control treated only with UP (denoted CK+UP) on the stem height (FIG. 12A) and stem weight (FIG. 12B) of snap dragon (Antirrhinum majus) grown in a field infested with root-knot nematodes in a first (filled red), second (crossed blue) and third (crossed red) harvest cycles;

FIGS. 13(A-B) are bar graphs presenting the effect of pre-plant soil disinfestation with Methyl Bromide (denoted MB), Condor® and Telodrip®, alone or in combination with post-plant application of an exemplary urea-phosphite formulation (denoted UP) according to the present embodiments, compared with a non-treated control (denoted CK) and a control treated only with UP (denoted CK+UP) on the galling incidence (FIG. 13A, red, blue and green bars represent a disease index of 2, 3 and 4, respectively) and galling index (FIG. 13B) of snap dragon (Antirrhinum majus) grown in a field infested with root-knot nematodes; and

FIGS. 14(A-C) are bar graphs presenting the effect of pre-plant soil disinfestation with Methyl Bromide (denoted MBr), Condor® and Telodrip®, alone (red bars) or in combination with post-plant application of an exemplary urea-phosphite formulation (denoted UP) according to the present embodiments (blue bars), compared with a non pre-plant infested control on the galling index (in a scale of 0-2) of roots of snap dragon (Antirrhinum majus) grown in a field infested with root-knot nematodes, at 3 different soil depths: 30 cm (FIG. 14A), 60 cm (FIG. 14B) and 90 cm (FIG. 14C).

### DESCRIPTION OF THE PREFERRED EMBODIMENTS

The present invention is of novel compositions which include a phosphorous-containing compound and a nitrogen-releasing compound, which can be used in the treatment of pests. These novel pesticidal compositions exhibit a synergistic pesticidal activity and are particularly useful in treating pests such as nematodes (including root-not nematodes), fungi and bacteria. The present invention is further of pesticide formulations containing the novel compositions and of methods utilizing these compositions for controlling pests.

The principles and operation of the present invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

As is discussed in detail in the Background section hereinabove, nematodes are plant parasites that pose one of the most serious economical damages in agriculture, and can attack almost all of the world's crops and ornamental plants. Nematodes are primarily found in the upper few inches of the soil, in the roots or in close proximity to the roots. In fact, most of the damage caused by nematodes is due to their feeding on plant roots, which has several adverse effects, starting from hypertrophy (or gall formation) on the plant surface, through plant stunting (underdevelopment of the plant), characterized by pale leaves and general sagging, and, in extreme cases, even the death of the plant. Furthermore, very often, nematode infestation may result in a reduced tolerance towards other pests, such as plant bacteria and soilborne fungi. It is therefore clear that substantial damage, both direct and indirect, is caused by nematodes and thus there is an obvious need to find new pesticides which are capable of eliminating or controlling the nematodes.

Different approaches have been used heretofore to eliminate nematodes in large soil areas. Presently employed techniques include soil and/or plant treatment, crop rotation using non-hosting plant varieties and, to a certain degree, the development of plants which are resistant to infestation. Unfortunately, known compounds, which are used for nematicidal soil and/or plant treatment, fail to efficiently address the problem due to drawbacks such as narrow spectrum of target pests, high phytotoxic effects, undesirable environmental impact, degradation and pest resistance induced by repeated use, and limited efficacy in controlling root-infesting pests. In the absence of an efficient method, the control of nematodes and additional pests is presently accomplished only by combining various methods, resulting in high costs of the control programs.

As is further mentioned in the Background section hereinabove, among known pesticides and fertilizers, it has been shown that phosphorus acid may control Oomycetes (see, for example, McGrath, 2004 and WO 00/062619, cited supra). In addition, some evidence suggests that phosphorous acid has an indirect effect by stimulating the plant's natural defense response against pathogen attack [Biagro Western Sales, Inc., supra; Smillie et al., 1989 supra]. However, as discussed hereinabove, the use of phosphorous acid alone in controlling root pests, and in particular root nematodes, is limited by poor efficiency (see, for example, Brown et al., 2004 supra), and is often further associated with phytotoxicity and/or development of resistance.

It has been further shown that urea, as well as other nitrogen-releasing compounds may act as nematicides (see, for example, Oka and Pivonia, 2002 and Sinclair, 1975). However, the use of these compounds in controlling pests is often limited by low nitrogen uptake by the plant. Hence, relatively large amounts of these compounds are required to achieve satisfactory results.

In a search for novel nematicides which would be devoid of the limitations associated with the currently used compositions, the present inventors have envisioned that compositions which combine a phosphorous acid-containing compound and a nitrogen-releasing compound could serve as efficient nematicides, while overcoming the limitations associated with the use of each of these components alone.

While reducing the present invention to practice, the present inventors have designed and successfully prepared novel compositions comprising phosphorous-containing compounds and nitrogen-releasing compounds. While further reducing the present invention to practice, it was surprisingly found that such compositions exert a synergistic nematicidal effect and are also highly effective in treating other pests.

Thus, as is demonstrated in the Examples section that follows, these novel compositions were found to be effective nematicides, and were found particularly efficacious in the treatment of root nematodes. The synergistic activity of the novel compositions was demonstrated with different types of soil, a variety of plants and pests, either alone or in combination with other pesticides. As is further demonstrated in the Examples section that follows, due to the synergistic effect of these novel compositions, lower concentrations of each of the active ingredients can be used and thus adverse side effects that are typically associated with such ingredients (e.g., phytotoxicity) are minimized.

Thus, according to one aspect of the present invention there is provided a pesticide composition, which comprises at least one phosphorous-containing compound selected from the group consisting of phosphorous acid, a salt thereof, a hydrate thereof and a solvate thereof, and at least one nitrogen-releasing compound.

While, as discussed hereinabove, the composition described herein is particularly effective against nematodes, according to another aspect of the present invention, there is provided a nematicide composition, which comprises at least one phosphorous-containing compound selected from the group consisting of phosphorous acid, a salt thereof, a hydrate thereof and a solvate thereof, and at least one nitrogen-releasing compound.

As used herein, the term “pesticidal” or “pesticide” with respect to a compound, composition or formulation, means any compound, composition or formulation intended for preventing, destroying, repelling, or mitigating a pest. Preferred pesticidal compounds, compositions or formulations according to the present embodiments are intended for use as plant regulators, defoliants, or desiccants. Non-limiting examples include fungicides, herbicides, insecticides, acaricides, nematicides, insect pheromones, rodenticides, biocides and microbiocides.

As used herein, the term “nematicidal” or “nematicide” with respect to a compound, composition or formulation, means any compound, composition or formulation intended for preventing, destroying, repelling, or mitigating of nematodes.

The term “phosphorous-containing compound”, as used herein, describes a compound that has one or more phosphorus (P) atoms. Phosphorous-containing compounds that are included within the scope of the present invention include phosphorous acid (H₃PO₃), derivatives, salts, hydrates and solvates thereof.

The term “salt” as used herein describes a charged species of the parent compound and its counter ion, which is typically used to modify the solubility characteristics of the parent compound, while not abrogating the activity and properties of the compound. An example, without limitation, of a salt would be a phosphonate anion and a cation such as, but not limited to, sodium, potassium, aluminum and the like. Phosphorous acid salts are also collectively referred to herein as phosphites.

The term “solvate” refers to a complex of variable stoichiometry (e.g., di-, tri-, tetra-, penta-, hexa-, and so on), which is formed by a solute (herein, the phosphorous-containing compound) and a solvent, whereby the solvent does not interfere with the activity of the solute.

The term “hydrate” refers to a solvate, as defined hereinabove, where the solvent is water.

Preferred phosphorous-containing compounds that are suitable for use in the context of the present invention include, without limitation, H₃PO₃, K₂HPO₃, KH₂PO₃, Na₂HPO₃, NaH₂PO₃, hydrates thereof, solvates thereof and any mixture of the foregoing.

The term “nitrogen-releasing compound” as used herein describes organic and inorganic compounds that may serve as a nitrogen source. Exemplary organic nitrogen-releasing compounds include urea, urea derivatives and amine-containing compounds, including derivatives thereof, salts thereof and any mixture thereof.

As used herein, the term “urea derivative” describes a compound having the formula NR₁R₂—C(═X)—NR₃R₄, where X can be O or S; and each of R₁-R₄ is independently hydrogen, alkyl, cycloalkyl or aryl, as these terms are defined herein, or, alternatively, two of R₁-R₄ form a ring. Representative examples include, without limitation, thiourea, N,N-dialkyl urea, O-alkyl urea, and the like. Preferably, the urea derivative is not biuret.

As used herein, the phrase “amine-containing compound” describes any organic substance that includes at least one free amine group.

As used herein, the term “amine” describes a —NR′R″ group wherein R′ and R″ are each independently hydrogen, alkyl, cycloalkyl, or aryl, as these terms are defined herein.

Examples of amine-containing compounds include, without limitation, alkylamines, dialkylamines, trialkylamines, amino acids, peptides, melamine, melamine cyanurate, dicyandiamide, cyanuric acid, cyamelide, guanidine, cyanoguanidine, ammeline and aminoguanidine, guanidine carbonate, ammonium carbonate, alkyl carbamates, alkyl isocyanates, polyisocyanates, sulfamic acid, ammonium sulfamate, polyamines, alkylanolamine, polyamides, amino hydrogen phosphates, amidines, amides, aldimines, ketimines, amino carbonates, aminoborates, amino sulfates, nitrites, and the like and any salts thereof.

Exemplary amine-containing compounds that were efficiently used within the compositions according to the present embodiments include amino acids. Amino acids can be incorporated in the compositions described herein either per se or as a part of a peptide that comprises two or more amino acid residues.

Amino acids that are suitable for use per se in the context of the present invention include the naturally occurring amino acids, namely, Alanine, Arginine, Asparagine, Aspartic Acid, Cysteine, Glutamic Acid, Glutamine, Glycine, Histidine, Isoleucine, Leucine, Lysine, Methionine, Phenylalanine, Proline, Serine, Taurine, Threonine, Tryptophan, Tyrosine and Valine, as well as any of the presently known modified amino acids. Representative examples of amino acids that were found particularly suitable for use in the context of the present invention include Cysteine, Aspartic acid and Lysine.

Exemplary inorganic nitrogen-releasing compounds include ammonia and ammonium salt. In one embodiment of the present invention, the nitrogen-releasing compound is other than ammonia or an ammonium salt.

As used herein, the phrase “ammonium salt” describes a compound having the formula NH₄+Y−, wherein Y is an inorganic anion, including, but not limited to, nitrate, sulfate, halide, and the like.

Exemplary ammonium salts therefore include, but are not limited to, ammonium nitrate, ammonium sulfate, ammonium phosphate, diammonium phosphate, ammonium polyphosphate, ammonium borate, ammonium hydrogen sulfate, quaternary ammonium salts, ammonium bicarbonate, ammonium carbonate, ammonium carbamate and any mixture thereof.

Any of the above-mentioned nitrogen-releasing compounds may be employed as the nitrogen-releasing compound of the composition either alone, or in combination with one of the other mentioned nitrogen-releasing compounds.

In an exemplary pesticide composition according to the present embodiments the nitrogen-releasing compound is urea and the phosphorous-containing compound is H₃PO₃. Preferably, the pesticide composition consists essentially of urea and H₃PO₃.

The amount of phosphorus-containing compound in the composition of the present embodiments can vary depending upon the activity, the presence and amount of other components in the composition, the object to which the composition is applied etc.

Thus, the amount of the phosphorous-containing compound in the composition can range from about 1 weight percentage to about 90 weight percentages of the total weight of the composition, from about 1 weight percentage to about 70 weight percentages, from about 1 weight percentage to about 50 weight percentages and preferably ranges from about 10 weight percentages to about 30 weight percentages

The amount of the nitrogen-releasing compound in the composition of the present embodiments can widely vary, depending upon reactivity, the presence and amount of other components in the composition and the object to which the composition is applied.

Thus, the amount of the nitrogen-releasing compound can range from about 1 weight percentage to about 90 weight percentages, from about 1 weight percentage to about 70 weight percentages, from about 1 weight percentage to about 50 weight percentages, from about 1 weight percentage to about 30 weight percentages, from about 10 weight percentages to about 30 weight percentages, and preferably ranges from about 10 weight percentages to about 25 weight percentages of the total weight of the composition.

A preferred pesticide composition according to the present embodiments comprises from about 10 weight percentages to about 30 weight percentages of a phosphorous-containing compound, as described in detail hereinabove; and from about 10 weight percentages to about 25 weight percentages of a nitrogen-releasing compound, as described and detailed hereinabove.

Hence, according to another aspect of the present invention there is provided a pesticide composition which comprises at least one phosphorous-containing compound selected from the group consisting of phosphorous acid, a salt thereof, a hydrate thereof and a solvate thereof, and at least one nitrogen-releasing compound, wherein an amount of the at least one phosphorous-containing compound ranges from 10 weight percentage and about 30 weight percentages of the total weight of the composition and an amount of the at least one nitrogen-releasing compounds ranges from 10 weight percentage and about 25 weight percentages of the total weight of the composition.

The pesticide composition according to the present embodiments may further comprise one or more metal ions.

The pesticide composition according to the present embodiments may further comprise in addition to the metal ion(s), one or more chelating agents, which may stabilize the metal ion, prevents its absorption is soil particles and increases its mobility is water and in wet soil.

The term “metal ion” as used herein describes a charged form of a metal, whereby the charge of the ion is determined by the valence of the metal. Exemplary metal ions that are suitable for use in the context of the present embodiments include, without limitation, ions of the elements of the second main group, in particular of copper, zinc and magnesium, as well as ions of aluminum, tin and lead, chromium, Manganese, iron, cobalt, nickel, zinc and others. Preferred metal ions include a potassium ion, a copper ion, a zinc ion, a manganese ion, an aluminum ion and any mixture thereof.

The amount of the metal ion preferably ranges from about 1 weight percentage to about 10 weight percentages of the total weight of the composition.

The phrase “chelating agent” as used herein describes a natural or synthetic compound that can interact with metal ions. Exemplary chelating agents that are suitable for use n the context of the present embodiments include, without limitation, EDTA, EDDHA, HEDTA, DTPA, citrate, saccharate, gluconate, glucoheptonate, and glycine.

As is widely taught in U.S. Pat. No. 6,689,392, to the present assignee, metal ions and chelating agents also act in synergy with phosphoric acid.

The molar ratio between the phosphorous-containing compound and the nitrogen-releasing compound in the composition according to the present embodiments can be in the range of from about 1:50 to about 50:1, from about 1:40 to about 40:1, from about 1:30 to about 30:1, from about 1:20 to about 20:1, from about 1:10 to about 10:1, from about 1:5 to about 5:1 and preferably ranges from about 2:1 to about 1:2.

Thus, preferred molar ratios between the phosphorous-containing compound and the nitrogen-releasing compound in the composition described herein are 2:1, 1:1 and 1:2.

As is demonstrated in the Examples section that follows, compositions that include these components in such a molar ratio were found to exert a synergistic nematicidal effect.

Thus, according to preferred embodiments of the present invention, the at least one phosphorous-containing compound and the at least one nitrogen-releasing compound act in synergy.

The terms “synergistic effect” or “synergy” refer to an effect which is greater than the predictive additive effect of the two individual components of the combination. In the present invention, the effect is a pesticidal effect, in particular a nematicidal effect.

In the field of agriculture, if it often understood that the term “synergy” is as defined by Colby S. R. in an article entitled “Calculation of the synergistic and antagonistic responses of herbicide combinations” published in the journal Weeds, 1967, 15, p. 20-22. The latter article uses the formula:

E=X+Y−XY/100

in which E represents the expected percentage of inhibition of the disease for the combination of the two fungicides at defined doses (for example equal to x and y respectively), X is the percentage of inhibition observed for the disease by the compound (I) at a defined dose (equal to x), Y is the percentage of inhibition observed for the disease by the compound (II) at a defined dose (equal to y). When the percentage of inhibition observed for the combination is greater than E, there is a synergistic effect.

The term “synergistic effect” is sometimes also calculated by the application of the Tammes method (“Isoboles, a graphic representation of synergism in pesticides” Netherlands Journal of Plant Pathology, 70 (1964), p. 73-80).

The synergistic effect exerted by the compositions described herein enables the use of relatively lower amounts of the active ingredients (e.g., phosphorous acid and a nitrogen-releasing compound), particularly as compared with the amounts required to achieve the same effect with each of these components alone. This feature is particularly advantageous since (i) it renders the use of such a composition relatively cost-efficient; and (ii) adverse side effects induced by each of the components are substantially reduced. Of particular importance is the use of relatively low concentrations of phosphorous acid, which, as discussed hereinabove and as further demonstrated in the Examples section that follows, is phytotoxic when used in high concentrations. Thus, for example, while a 50% phosphorous acid composition is presently marketed as a nematicide, the novel compositions of the present invention were highly effective as nematicides using as little as 10 to 30 weight percentages. Given the adverse effects associated with high phosphorous acid or salt concentrations, for example the known phytotoxic effect thereof, this reduction in the phosphorous containing compound concentration, has an important agricultural and economical significance.

As described in detail hereinafter, without being bound to any particular mechanism, it is suggested that the synergistic effect of the compositions described herein is due to a mechanism by which the development and growth of the plant giant cells, originally induced by the nematodes, are suppressed, thus depriving the nematode of their main feeding channel, leading to nematode starvation and death.

In another preferred embodiment of the present invention, when applied to plants, the pesticide composition described herein is capable of inducing systemic resistance to a plant.

As is well known in the art, the phrase “inducing systemic resistance” refers to a pesticidal activity that results in resistance (or tolerance) against subsequent challenge by a pest. In a classic model of systemic disease resistance, a leaf, in response to a disease attack, produces a signal (for example, the production of salicylic acid). This signal moves through the vascular system of the plant to uninfected leaves, where it induces the formation of phytoalexins (defensive chemicals) and associated resistance against further disease attack.

The pesticidal compositions described herein cause a similar reaction in the plant, whereby the resistance to the pest is imprinted in the plant. Thus, the effect of the pesticide composition is largely prolonged and enables the plant to withstand future attacks by the pest, without adding further pesticide amounts.

It is noteworthy that pesticide compositions that are capable of inducing systemic resistance are far superior to pesticide compositions that are only beneficial in topical treatment of pests.

As is further demonstrated in the Examples section that follows, the composition described herein was found particularly efficient in the treatment of nematodes and particularly root-knot nematodes. Hence, the composition is particularly useful as a nematicide composition.

Furthermore, as detailed in the Background section hereinabove, some nematodes create specialized feeding sites in their hosts by injecting certain secretions into the root cells, thereby enlarging the cells (Trudgill 1999/00 supra). These “giant cells” then transfer nutrients from the plant cell to the nematode, leading to poor nutrition of the plant. Now, without being bound to any particular mechanism, it is suggested that when the pests are nematodes, the nematicidal effect of the compositions described herein is due to a mechanism by which the plant giant cells, originally induced by the nematodes, remain in their original size, and therefore cannot function as a “sink” for accumulating nutritional materials, causing deprivation of the nematodes of their main feeding channel and leading to their starvation and death.

Thus, according to preferred embodiments of the present invention, the nematicide composition described herein acts by inhibiting the development of giant cells of a plant. Yet, the nematicide compositions described herein may act via other mechanisms.

The composition described herein can be prepared by simply mixing the nitrogen-releasing compound and the phosphorus-containing compound at room temperature in the presence of a solvent, whereas the nitrogen-releasing compound and the phosphorus-containing compound may be added one to the other, or vice versa, without affecting the yield or product. Optionally and preferably, the solvent is an aqueous solution (e.g., water).

While different solvents can be used in the process of preparing the pesticide compositions, preferably, the solvent is selected to be an agriculturally acceptable carrier, such that isolation of the composition and formulating in an agriculturally acceptable formulation can be circumvented. An exemplary solvent that can further act as an agriculturally acceptable carrier is water.

For example, as is demonstrated in the Examples section that follows, compositions of urea and H₃PO₃ were simply prepared by mixing, at room temperature, an aqueous solution of urea and H₃PO₃.

Conducting the reaction at room temperature prevents the formation of urea condensates byproducts such as the undesirable biuret, which are typically formed at elevated temperatures (i.e., above 70° C.). Furthermore, conducting the reaction at room temperature is also advantageous in facilitating the process of preparation, and maintaining a low cost of production while providing an easily applicable method for the preparation of effective pesticidal and nematicidal compositions.

As discussed above, the pesticide composition according to the present embodiments may also comprise one or more metal ions and optionally one or more chelating agents. These compositions can be prepared, as discussed hereinabove, by simply mixing the nitrogen-releasing compound, the phosphorus-containing compound and the metal ion and optionally the chelating agent, at room temperature in the presence of a solvent.

The pesticide composition presented herein can be used in any of the applications described hereinbelow either per se or as a part of a pesticide formulation, which further comprises a carrier.

Thus, according to another aspect of the present invention there is provided a novel pesticide formulation, which comprises at least one phosphorous-containing compound as described herein, at least one nitrogen-releasing compound as described herein, and a carrier.

The term “carrier”, as used herein, describes an inert material with which the composition is mixed or formulated to facilitate its application, or its storage, transport and/or handling. The carrier can be solid (e.g., clays, natural or synthetic silicates, silica, resins, waxes, or solid fertilizers) or liquid (e.g., water, alcohols, ketones, petroleum fractions, aromatic or paraffinic hydrocarbons, chlorinated hydrocarbons, or liquefied gases).

Since the pesticide composition described herein is particularly useful for controlling pests in crops, the carrier is preferably an agriculturally acceptable carrier.

The term “agriculturally acceptable carrier” as used herein refers to an inert, environmentally acceptable carrier, which is not harmful to the crops.

Preferred carriers that are suitable for use in the formulation described herein include liquid carriers. A suitable carrier can be an aqueous carrier and/or an organic carrier. Preferably, the carrier is an aqueous carrier and more preferably the carrier is water.

The pesticide formulation of the present invention may further include one or more additive(s), which may improve its performance, efficiency, versatility and/or economics. Representative examples include, but are not limited to, protective colloids, acidifying agents, adhesives, thickening agents, penetrating agents, stabilizing agents, sequestering agents, fertilizers, pesticides, anti-freeze agents, repellents, color additives, corrosion inhibitors, water-repelling agents, siccatives, UV-stabilizers, pigments, dyes and various polymeric substances.

The term “protective colloid”, as used herein, describes a surface active compound which prevents coagulation of the pesticide formulation.

As used herein, the term “acidifying agent” describes a compound used to provide an acidic medium for product stability. Such compounds include, by way of example and without limitation, acetic acid, acidic amino acids, citric acid, fumaric acid and other alpha hydroxy acids, hydrochloric acid, ascorbic acid, phosphoric acid, sulfuric acid, tartaric acid and nitric acid and others known to those of ordinary skill in the art. The addition of the acidifying agent results in a low pH of the solution, which contributes to the solubility of ions. Moreover, the availability of ionic microelements to plant roots is increased in low pH. Therefore, the acidifying agent in the composition improves solubility, mobility in soil and availability of fungicidal and bactericidal ionic metals to the plant.

The term “adhesive” includes an adhesive base, a potentially adhesive base, a binder, an adhesive suspending medium, a gum, other adhesive colloidal material, a gelatin or the like.

The term “thickening agent” refers to a compound or combination of compounds which acts to increase the viscosity of a liquid solution or suspension. Preferably a thickening agent is not present in such a large amount as to result in solidification of the composition. A wide variety of thickening agents may be used to prepare the stable formulations of the present invention. Suitable thickening agents include any and all biocompatible agents known to function as thickening agents. In a preferred embodiment of the present invention, the thickening agent is selected from the group consisting of polyethylene glycol, propylene glycol, glycerin, and polyvinylpyrrolidone.

The term “penetrating agent” as used herein means an organic compound that can be used to promote penetration of the composition to the treated object. Examples of penetrating agents that promotes penetration to e.g., plants, include, without limitation, esters (i.e. ethyl acetate, propyl acetate, butyl acetate, amyl acetate, and combinations thereof), ketones (i.e. acetone and methylethylketone), methylene chloride, chloroform and dimethyl sulfoxide.

The term “stabilizing agent,” as used herein, describes compounds which increase the stability of the composition.

The term “sequestering agent” describes an agent which affects the availability of an ion in a solution. A sequestering agent may be a chelating agent (ligand) which forms a complex with a dissolved ion and retards the ion from forming a more stable complex with another ligand.

The term “fertilizer” is used herein to denote a primary nutrient that is required by all plants in considerable quantities for plant growth. The term “anti-freeze agent” or “freeze point depressant” includes, without limitation, relatively low molecular weight aliphatic alcohols such as ethylene glycol, propylene glycol, glycerin, hexane diol, and sorbitol. Preferred anti-freeze agents include dipropylene glycol, glycerin, hexylene glycol, and propylene glycol.

The term “repellent” or “repellent composition” as used herein is a composition of matter, including mixtures, which effectively repels or discourages pests.

The term “color additive” as used herein includes a dye, pigment, or other compound that when added or applied to a formulation is capable of imparting color thereto.

Included in the term “pigment” herein are inorganic pigments sometimes referred to as “fillers” such as, for example, clay. A preferred predominant pigment is, without limitation, titanium dioxide.

The term “dyes” is used to describe all coloring materials, either organic or inorganic, that are capable of being dissolved or dispersed in carrier solvents and liquid media.

The term “corrosion inhibitor” as used herein includes any commercially available product that may inhibit corrosion, or any blend of corrosion inhibiting products. Representative examples of corrosion inhibitor agents that are suitable for use in the context of the present invention include, without limitation, steepwater and sodium citrate.

The term “water repellent” is used herein to describe materials which are not water wettable and are capable of preventing the passage of liquid water through the packaging material under varying ambient atmospheric conditions, including water impinging on the surface of the packaging material.

The term “siccatives” is used herein to describe those protective and/or decorative coatings such as shellac, varnishes, phenolic varnishes, paints of the drying-oil types, cathodic electrodeposition paints, and paints which fall into the classes of alkyds, modified alkyds, modified phenolics, modified melamines, baked phenolics, epoxy-resins, polyurethanes, silicones, acrylics, vinyls, and the like. The term “UV-stabilizers” is used herein to describe compounds capable of screening ultraviolet rays of the sun. Representative examples of UV-stabilizers that are suitable for use in the context of the present invention include, without limitation, various substituted resorcinols, salicylates, benzotriazole, benzophenone, and the like.

As used herein, the term “polymers” encompasses the addition of monomers, or single unit material, which function to increase the viscosity and/or density of the pesticide formulation.

According to a preferred embodiment of the present invention, the formulation can include, in addition to the pesticide composition described herein and any of the above-cited optional additives, one or more additional pesticides.

Exemplary pesticides that can be used in the context of the present invention include, but are not limited to, fungicides, such as, but not being limited to fenpropidin, cymoxanil, guazatine and fludioxonil; herbicides, such as, but not being limited to, diflufenican, flumetsulam, 2-methyl-4-chlorophenoxy-acetic acid (MCPA), and diuron; insecticides, such as, but not limited to, oxamyl, phosphocarb, imidacloprid and tebufenpyrad; acaricides, such as, but not limited to, abamectin, chlorobenzilate, methiocarb and vamidothion; miticides such as, but not limited to, bifenazate, dicofol, fluazuron and pyrimidifen; nematicides, such as, but not limited to, aldicarb, fenamiphos, oxamyl and phosphocarb; insect pheromones, such as, but not limited to, (E,E)-8,10-dodecadienol, dodecane-1-ol, (E)-11-tetradecen-1-ol, (Z)-9-tetradecen-1-ol, (Z)-[1-hexadecene-1-ol; rodenticides, such as, but not limited to, difenacoum, brodifacoum, bromadiolone, coumatetrayl and warfarin; and biocides and microbiocides, such as, but not limited to, bronopol, 2-bromo-2-nitropropan-1-ol, 4,4-dimethyl-1,3-oxazolidine, chlorhexidene and pyrithiones.

The concentration of the pesticide composition in the formulation described herein can range from about 0.001 weight percentage to about 1 weight percentage of the total weight of the formulation, from about 0.001 weight percentage to about 0.5 weight percentage, from about 0.01 weight percentage to about 0.5 weight percentage, from about 0.01 weight percentage to about 0.3 weight, from about 0.1 weight percentage to about 0.2 weight percentage. More preferably, the concentration of the composition ranges from about 0.05 weight percentage to about 0.2 weight percentage of the total weight of the formulation.

As is shown in the Examples section which follows, when such a formulation was applied to various soil types, highly efficacious nematicidal effect was obtained while no phytotoxic effect was observed.

The pesticide formulations described herein may be either in a solid form or in a liquid form, and occasionally may be in the gaseous form, as in aerosols. Preferred pesticide formulations include, but are not limited to, solids, solutions, dispersions, suspensions, pastes and sprays. Specifically, the pesticide formulations may be in the form of powders, wettable powders, dispersible or soluble granules, water-soluble concentrates, suspension concentrates or pastes.

The concentration of the pesticide composition in the formulation can vary widely depending upon the formulation form.

Typically, wettable powders (or sprayable powders), as well as dispersible granules, contain from about 20 to about 95 weight percentages of pesticide compositions and, in addition to the solid carrier, from 0 to about 5 weight percentages of a wetting agent, from about 3 to about 10 weight percentages of a dispersing agent and, when necessary, from 0 to about 10 weight percentages of one or more stabilizing agents and/or other additives, such as pigments, dyes, penetrating agents, adhesives, or anti lumping agents. It is well understood that some of these compositions, such as wettable powders or dispersible granules, are intended to constitute liquid compositions at the time of application.

Soluble concentrates typically comprise from about 10 to about 80 weight percentages of a pesticide composition. Solutions ready for application typically contain from about 0.01 to about 20 weight percentages of a pesticide composition. As mentioned hereinabove, with respect to aqueous dispersions, for example, the compositions obtained by diluting a wettable powder according to the embodiments of the present invention with water, are within the general scope of this invention.

The suspension concentrate, also applicable by spraying, is a stable fluid product, which does not thicken or form a sediment after storage, and it generally contains from about 10 to about 75 weight percentages of a pesticide composition, from about 0.5 to about 15 weight percentages of surface-active agents, from about 0.1 to about 10 weight percentages of thixotropic agents and from 0 to about 10 weight percentages of suitable additives, such as pigments, dyes, antifoaming agents, corrosion inhibitors, stabilizing agents, penetrating agents and adhesives and, as vehicle, water or an organic liquid in which the compositions are insoluble or nearly insoluble. Certain organic solid materials or inorganic salts can be dissolved in the vehicle to aid in preventing sedimentation.

Thus, in order to obtain sprayable or wettable powders, the pesticide compositions are typically intimately mixed, in suitable mixers, with the optional additives described herein, and the mixture is milled with mills or other grinders. Powders to be sprayed are thereby obtained with advantageous wettability and suspensibility; they can be suspended in water at any desired concentration and these suspensions can be used very advantageously.

Pastes or suspension concentrates can also be similarly produced. The conditions and modes of production and use of these pastes are similar to those of wettable powders or powders to be sprayed, whereby part of the milling operation is carried out in a liquid medium.

Preferably, the concentration of the solute or solutes in the pesticide formulation of the present invention is at least 5 weight percentages, more preferably at least 10 weight percentages, and most preferably is about 20 weight percentages.

Each of the formulations described herein may be packaged in a packaging material and identified in print, in or on the packaging material, for use in controlling pests.

Thus, according to another aspect of the present invention there is provided an article-of-manufacture which comprises a packaging material and the composition or formulation described herein packaged in the packaging material, whereby the article-of-manufacture is identified for use in controlling pests.

Given the synergistic effect demonstrated for the compositions and formulations according to the present embodiments, such compositions and formulations can be beneficially utilized in various methods for controlling pests.

Thus, according to an additional aspect of the present invention there is provided a method of controlling pests. The method, according to this aspect of the present invention, is effected by contacting a substance, a product or a structure with a pesticidal effective amount of the composition described hereinabove.

As used herein the term “substance” refers to any solid matter which may harbor pests, such as a soil.

As used herein, the term “product” refers to any commodity or plant material which may harbor pests.

As used herein, the term “structure” refers to any structure which may harbor pests such as a building, warehouse, compartment, container or transport vehicle.

As used herein, the term “plant” or “plant material” includes any or all of the physical parts of a plant, including seeds, seedlings, saplings, roots, tubers, stems, stalks, foliage, and fruits.

As used herein, the term “plant growth” includes all phases of development from seed germination to natural or induced cessation of life.

As is demonstrated in the Examples section that follows, an exemplary composition according to the present embodiments was found to be synergistically effective in treating a variety of plants, such as tomato and snap dragon plants, showing its beneficial effect on various physical parts of the plants, such as leaves, roots, flowers and stems thereof.

Thus, in a preferred embodiment of the present invention, the method according to this aspect of the present invention is utilized for controlling pests in products such as plants, whereby the composition or formulation described herein is applied to the soil onto which the plants are grown.

Preferably, treating soil with an effective amount of the formulations described herein is directed at controlling pests such as nematodes, fungi and bacteria.

As used herein, the term “soil” refers to any natural or synthetic soil or other medium used for growing plants such as, for example, peat moss, perlite, vermiculite, etc., or mixtures thereof.

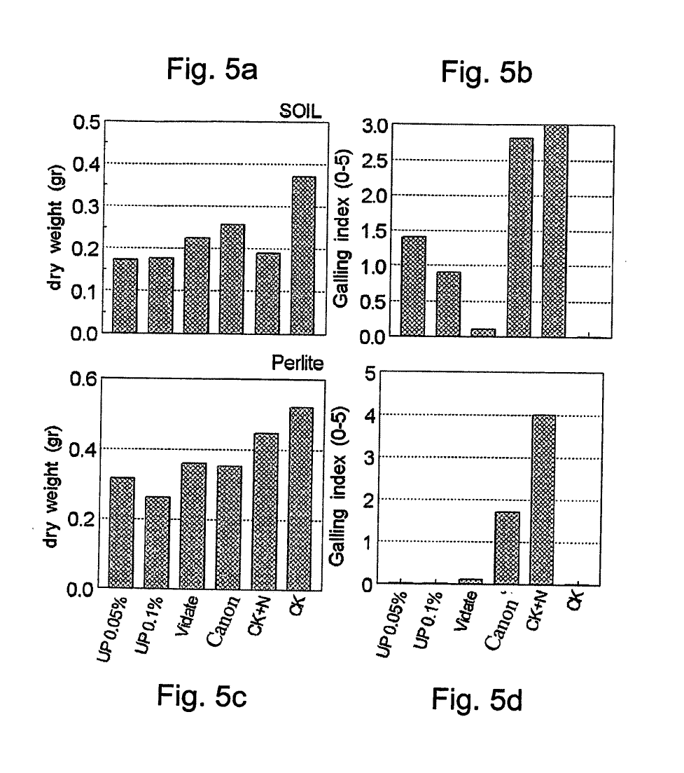

As is demonstrated in the Examples section that follows, an exemplary composition according to the present embodiments was found effective in reducing nematode galling in both natural and artificial soil, having a more pronounced effect in artificial soil than in natural soil (see, for example, FIGS. 5B and 5D).

As used herein, the term “control” or “controlling” refers to inhibiting the growth of pest populations or colonies present in a substance, product or structure.

As used herein, the term “pest” refers to any organism which is damaging to crops, humans and/or animals, including pathogenic, parasitic and competitive organisms. Non-limiting examples include insects, rodents, nematodes, fungi, weeds, bacteria, as well as any form of life declared to be a pest.

The following provides examples of pests which infest substances or products and can be targeted by the method according to this aspect of the present invention.

Examples of soil colonizing (soil-borne) pests include any soil-borne plant pathogenic fungi, plant pathogenic bacteria, plant pathogenic nematodes, plant insects and weeds.

Soil-borne pathogenic fungi include, but not limited to, Cylindrocarpom spp., Fusarium spp., Phoma spp., Phytophthora spp., Pythium spp., Rhizoctonia spp., Sclerotinia spp., Verticillium spp. and Macrophomina spp. Soil-borne plant pathogenic bacteria include, but not limited to Pseudomonas spp., Xanthomonas spp., Agrobacterium tumefaciense, Corynobacterium spp. and Streptomycess spp.

Plant pathogenic nematodes include, but not limited to, Meloidogyne spp., Xiphinema spp., Pratylenchus spp., Longidorus spp., Rotylenchulus spp., Helicotylenchus spp., Hoplolaimus spp., Paratrichodorus spp., Tylenchorhynchus spp., Radopholus spp., Anguina spp., Aphelenchoides spp., Bursaphelenchus spp., Ditylenchus spp., Trichchodorus spp., Globodera spp., Hemicycliophora spp., Heterodera spp., Dolichodorus spp., Criconemoides spp., Belonolaimus spp. and Tylenchulus semipenetrans.

Soil-borne plant insect pests include, but not limited to wireworms, thrips, beetle larva, grubs, fungal gnat larvae, mealy bugs, phylloxera, ants and termites. Weeds include, but not limited to, purple nutsedge (Cyperus rotundus), smooth pigweed (Amaranthus hybridus), barnyard grass (Ecinochlea crus-galli), cheeseweed (Malva spp.), field bindweed (Convolvulus arvensis), annual bluegrass (Poa annua); bermuda grass; crab grass; foxtail; purs lane; and witchweed.

Examples of product or space colonizing pests include any plant or animal insects such as, but not limited to, stored product insects (e.g., Tribolium spp., Rhizoperha dominicana, Oryzaephilus surinamensis, Ephestia spp. and Plodia interpunctella), mediterenian fruit fly (Ceratitus capitata), other fruit flies, white flies, fruit weevils, lepidoptera, beetles, scale insects, aphids, mealy bugs, thrips, and termites. Additional commodity colonizing pests include nematodes, plant pathogenic fungi and wood decay fungi.

The present compositions can be utilized for controlling pests by exposing a substance or product or a structure harboring the pest, to a pesticidally effective amount of the present compositions. Preferably, the substance is a soil.

As used herein, the term “pesticidally effective amount” describes an amount or concentration of a composition or a formulation, respectively, as these terms are defined herein, that will provide the pesticidal effect for which the composition is indicated, herein, controlling pests. Preferably, the pesticidal effect involves also inducing systemic resistance in pests.

As used herein, the term “nematicidally effective amount” describes an amount or concentration of a composition or a formulation, respectively, as these terms are defined herein, that will provide the nematicidal effect for which the composition is indicated, herein, controlling nematodes.

Preferably, and as is delineated hereinabove, the nematicidal effect is achieved through a mechanism by which the nematicide acts by inhibiting the development and/or growth of plant “giant cells”, originally induced by the nematodes.

The formulations described above can be applied to the substance, product or surface, using any one of several techniques, such as fumigating, spraying, drenching, soaking, dipping, mixing, coating, dispersing, injecting, irrigating or impregnating.

As used herein, the term “fumigating” or “fumigation” refers to administering a gas phase pesticide (e.g., in the form of fume or vapor) formulation.

Various disinfection techniques are known in practice. Preferably, the specific disinfection technique utilized is selected according to the type of substance, product or space disinfected and further according to the pest targeted.

Application of the pesticide compositions or formulations described herein can be effected either prior to transplanting and/or during transplanting and/or during crop season.

Treatment of a large-scale areas can be effected, for example, by applying the pesticide composition or formulation to the soil via the irrigation system (chemigation). The pesticide can be accurately metered into the irrigation lines to ensure an even distribution throughout the field. Preferably, the pesticide is applied via a drip irrigation system to a properly prepared soil already covered with plastic tarps to improve the efficacy of treatment.

Soil treatment of small-scale areas, such as experimental plots, nurseries, ornamental plantings and orchards, the pesticide composition or formulation can be hand-injected to soil using equipment with a holding tank connected to a hollow pointed base for penetrating the soil. A plunger device or drip device releases a known amount of pesticide for each penetration.

Alternatively, the pesticide composition or formulation can be mixed in water and applied by drench. Preferably, the treated soil is covered with a plastic tarp immediately following treatment to improve the efficacy of the pesticide composition or formulation. Preferably, the tarp is removed from the soil after an exposure period ranging from one to eleven days following pesticide application, then the soil is allowed to aerate.

The method according to this aspect of the present invention can be combined with one or more other disinfestation methodologies, which are effected prior to, concomitant with and/or subsequent to the application of the composition or formulation described herein.

As used herein, the term “disinfecting” or “disinfection” refers to inactivating or killing weeds and pests which colonize the substance or product targeted for disinfection.

Thus, for example, soil treatment can be further combined with other agriculturally acceptable soil disinfection methodologies, either prior to, concomitant with, or subsequent to a treatment that employs the pesticide composition or formulation described herein. Preferably, such disinfection is conducted prior to such a treatment.

Examples of soil disinfection techniques that can be utilized according to this embodiment of the present invention include, but are not limited to, soil solarization, soil steaming and band steaming.

Soil solarization (also referred to herein and in the art as solar heating) is a common pre-planting soil disinfestation method. It is conducted by covering, mulching or tarping the soil with transparent sheets, usually polyethylene, during the hot season, thereby heating it and killing the pests. Soil steaming is another soil disinfection method in which steam is applied to the whole bed area and down to 50-100 mm soil depth (depending on the steaming time).

A wide range of application rates of the formulations described herein may be suitable for soil disinfection according to the teaching of the present invention and may vary for any given combination of crops, soils types and the target pests.

According to a preferred embodiment of the present invention, a pesticidally effective application rate of the pesticide formulation ranges from about 1 liter/1000 m² to about 100 liters/1000 m², and preferably, from about 1 liter/1000 m² to about 5 liters/1000 m². Applications at rates substantially in excess of 5 liters/1000 m² would not be expected to provide any significant advantage over applications within the preferred ranges specified herein, but are nonetheless regarded as well within the scope of the present invention. More preferably, a pesticidally effective application rate of the pesticide formulation described herein ranges from about 1 liter/1000 m² to about 100 liters/1000 m², more preferably from about 1 liter/1000 m² to about 50 liters/1000 m², more preferably from about 1 liter/1000 m² to about 20 liters/1000 m², more preferably from about 1 liter/1000 m² to about 10 liters/1000 m², more preferably from about 2 liter/1000 m² to about 4 liters/1000 m², and even more preferably, from about 2 liter/1000 m² to about 3 liters/1000 m².

The formulations described herein can also be used in the treatment of commodities and structures, including open or closed space treatment. Preferably, an effective amount of the present compositions is affected by heating the pesticide, such as by passage through a heat exchanger, prior to delivery to a commodity or a structure. The treated commodity may be contained in a gas-tight compartment or covered with a gas-tight plastic tarp. The exposure of the commodity to the pesticide may affect it for a period ranging from one to ten days. Following exposure, the pesticide is removed and the treated commodity is allowed to aerate for at least one week, more preferably for at least two weeks, most preferably for at least three weeks, prior to allowing access the treated commodity.

As in soil treatment, the treatment of substances or structures can be further combined with a disinfection step, either before, together with, or after the treatment step. Preferably, the disinfection is conducted prior to the treatment.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions, illustrate the invention in a non limiting fashion.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below.

### Materials and Experimental Methods

Canon® (50% phosphorous acid), a commercially available post-plant foliar fungicide was purchased from Luxembourg Ltd. Israel. Vidate®, a commercially available post-plant nematicide, was purchased from Du-Pont.

Preparation and Analysis of a Urea-Phosphite Composition:

An exemplary Urea-Phosphite (UP) composition having a 1:1 urea:phosphite molar ratio was prepared as follows:

Urea (120 grams) was dissolved in water (716 grams). Then, H₃PO₃ (160 grams) was added to the solution while continuously mixing. All preparations and handling of the UP formulation were conducted at room temperature.

Determination of phosphite (PO₃⁻³) concentration in solution was performed by iodometric titration (I. M. Kolthoff, R. Belcher, Volumetric Analysis, vol. III titration methods: Oxidation-Reduction Reactions, 1957, Interscience Publishers, Inc., New York). Urea was determined via a calorimetric comparison against a standard urea/hydrazine reagent.

Analysis of the resulting solution showed it contains 28.4% of the urea-phosphite composition (composed of 16.4% phosphite and 12% urea and corresponding to a 1:1 molar ratio).

Similar urea phosphite compositions having higher concentrations were prepared using the same procedure. In one example, a 50% composition of a 1:1 urea:phosphite molar ratio, was analyzed as containing 29% phosphite and 21.1% urea.

Other compositions according to the present embodiments, containing other nitrogen-releasing compound, as detailed hereinunder, were similarly prepared, using various nitrogen-releasing compounds and various phosphorous-containing compounds as starting materials. Whenever the reaction proved to be exothermic (for example, during the preparation of ammonium phosphite, diammonium phosphite, or when using potassium phosphite), the reaction temperature was controlled via external cooling and/or a slow addition of the nitrogen-releasing compound to the phosphorous acid or its salt.

### Activity Studies

Activity studies were conducted in two systems:

greenhouse experiments; and

(ii) field experiments.

Greenhouse Experiments:

The incidence and severity of nematode infection (galling index) as well as the effect on plant development and the phytotoxic effects, of exemplary formulations according to the present invention, were tested and compared with known nematicides, on various plants and/or various soil types.

General Protocol: tomato transplants, at a stage of two true leaves, were planted in pots filled with sandy Rehovot soil (ten pots per treatment, one plant in each pot). The soil was not infested with any known tomato pathogen. Two applications of each treatment, as detailed below, were conducted, 3 days and 10 days after planting. Treatment was performed by drenching each pot with 50 ml of the treatment solution. Nematode inoculation was conducted one week after planting. The inoculum of Meloidogyne javanica was prepared by macerating infected tomato roots in tap water. Few hours later the eggs and first stage larvae were counted. The inoculum density was adjusted to 1000 units (eggs and larvae) in each pot. The sequence of inoculation and chemical application is presented in Table 1 below. Following nematode inoculation, plants were grown in a controlled greenhouse temperature of 25° C. After four weeks, the plants were uprooted with the whole root system, and various features of plant development (e.g., fresh and dry weights of the foliage, height) and nematode infection were measured for each plant. The sequence of inoculation and chemical application is presented in Table 1 below.

The nematode infection in the roots was rated based on a galling index in a scale of 0-5, where 0 represents no infection (clean healthy roots); 1 represents galls on 10% of the root volume; 2 represents galls on 25% of the root volume; 3 represents galls on 50% of the root volume; 4 represents galls on 75% of the root volume, and 5 represents galls on 100% of the root volume.

Each of the treatments was applied on both nematode-inoculated and non-inoculated pots. The control included non-treated nematode-inoculated and non-inoculated pots.

As indicated below, some of the experiments were conducted without nematode inoculation, for assessing phytotoxicity only. The phytotoxic effect was measured visually.

As is further indicated below, some of the experiments were conducted with Hyperikum plants.

As is further indicated below, some of the experiments were conducted with an artificial soil (perlite).

TABLE 1

| | Day | | | | |
|---|---|---|---|---|---|
| | −7 | −3 | 0 | +3 | +28 |
| Action | Transplanting | 1^{st}Application | Nematode | 2nd Application | Uprooting and |
| | | of chemical | inoculation | of chemical | infection rating |
| Plant | 2 true leaves | | 4 true leaves | | |
| stage | | | | | |

Field Experiments:

Two experiments were conducted in the field:

(i) Comparable experiments for evaluating the effect of post-plant application of various UP formulations according to the present embodiments on the plant development and disease index of snap dragon transplants grown in a nematode-infected field (see, general protocol I); and

(ii) Comparable experiments for evaluating the effect of pre-plant soil disinfestations by various known pesticides, followed by post-plant application of exemplary UP formulations according to the present embodiments on the plant development and disease index of snap dragon transplants grown in a nematode-infected field (see, general protocol II).

Experiments were conducted in the Be'sor experimental station, Israel in a field which was heavily infested with the root-knot nematodes Meloidogyne javanica and other soilbome fungal pathogens.

General Protocol I:

Transplants of snap dragon (Antirrhinum majus), a plant susceptible to root-knot nematodes, were planted and subjected to various treatments, as detailed below. Each treatment was repeated 5 times, using a Latin Square Design. The chemicals were drenched with a volume of 3 liters/m². Two chemical applications were done, the first 3 weeks after planting and the second 4 weeks thereafter (total of 2 chemical applications. The field was fertilized and irrigated according to the commercial practice in the region. Flower stems were harvested during crop growth and graded according to commercial scale. Three months after planting, the plants were uprooted and the nematode infection in the roots was rated based on a galling index in a scale of 0-4, where 0 represents no infection (clean healthy roots); 1 represents galls on 25% of the root volume; 2 represents galls on 50% of the root volume; 3 represents galls on 75% of the root volume; and 4 represents galls on 100% of the root volume

General Protocol II: Soil disinfestation treatment was conducted on plots which were 8 meters long and 6 meters wide (four beds). Each disinfestation treatment was conducted in a randomized block design with four replicates, and was combined with soil solarization for 4 weeks. About 2 months later, transplants of snap dragon (Antirrhinum majus) were planted. Throughout the crop growth, 0.1% urea-phosphite (UP) was applied via the drip irrigation system, to 2 beds in each plot. The dosage of UP was calculated as a concentration of the composition compared to the volume of the irrigation water which were applied. The UP formulation was applied repeatedly at 3 weeks intervals, then 5 weeks intervals, and again at 3 weeks intervals. The field was fertilized and irrigated according to the commercial practice in the region. Damping-off of the plants was measured one month after planting. Flower stems were harvested during 3 cycles and graded according to a commercial scale. The yield of flower stems in each bed, as well as stem weight and length was measured.

About 9 months after planting, a sanitation program was performed on half of the bed: 1,3-dichloropropene (EC) at a rate of 10 grams/m² was applied via drip lines in order to kill the roots and the nematodes being in association with the roots. One week after the sanitation treatment the plants were uprooted and the nematode infection in the roots was rated based on a galling index in a scale of 0-4, where 0 represents no infection (clean healthy roots); 1 represents galls on 25% of the root volume; 2 represents galls on 50% of the root volume; 3 represents galls on 75% of the root volume; and 4 represents galls on 100% of the root volume.

In addition, about 9 months after planting, soil samples were taken from each plot at three depths of 20-30 cm, 50-60 cm and 80-90 cm. The samples were filled in pots and tomato transplants at a stage of two true leaves were planted in pots. The plants were grown for 4 weeks, after which they were uprooted with the whole root system. The nematode infection in the roots was rated based on a galling index at a scale of 0-2 where, O-clean roots; 1 few galls: 2-roots full with galls.

### EXPERIMENTAL RESULTS

### Greenhouse Experiments

Using the general protocol described in the methods section hereinabove, the incidence and severity of nematode infection (galling index) as well as the effect on plant development and the phytotoxic effects, of exemplary compositions according to the present invention, were tested and compared with those of known nematicides such as Canon®, on various plants.

Phytotoxic Effect:

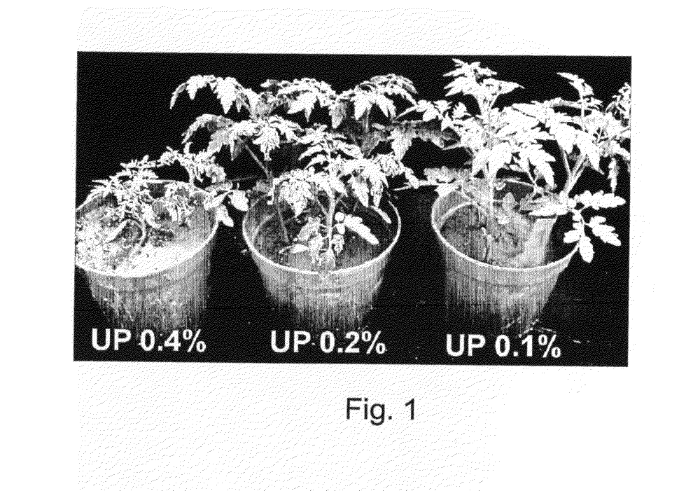

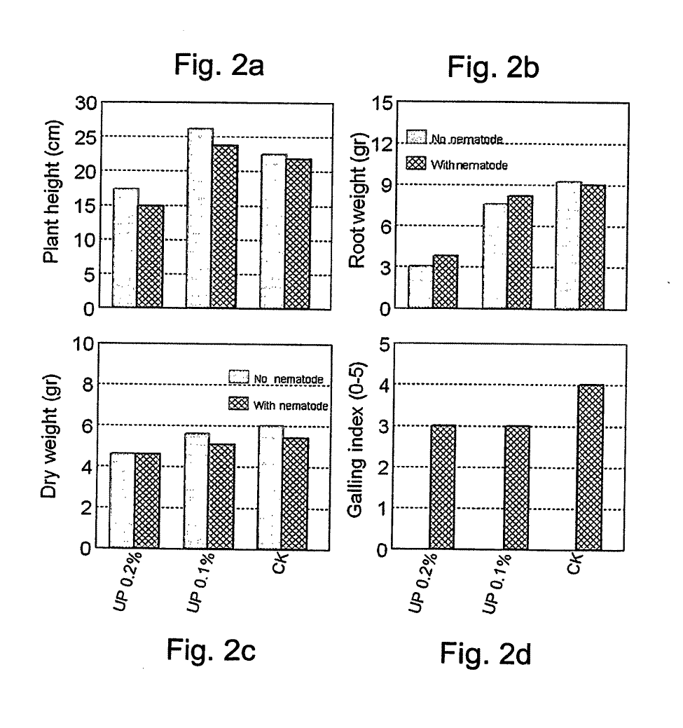

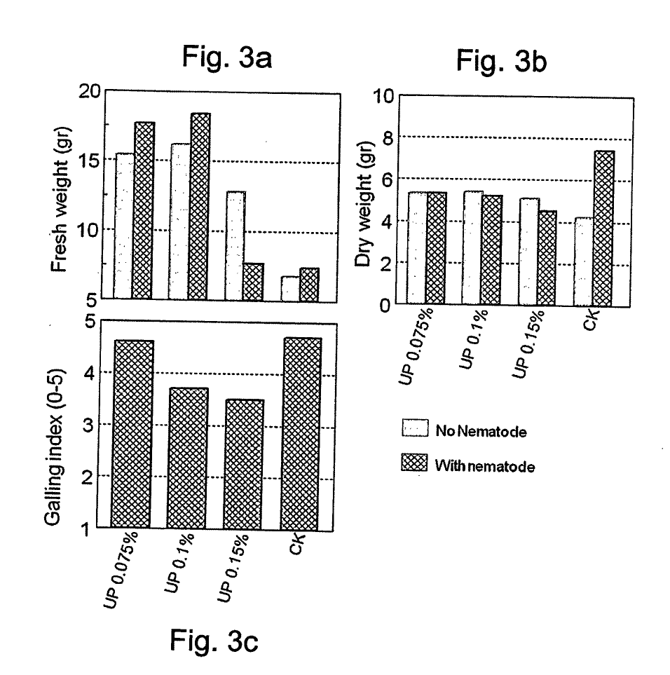

The phytotoxic results are presented in FIG. 1 and clearly show that while in a concentration of about 0.1% UP no phytotoxic effect was observed, using UP at a concentration of about 0.2% resulted in clear phytotoxic symptoms of leaf chlorosis and stem necrosis, whereby at a concentration of 0.4% plants were stunted and some died. Based on these results, UP formulations at concentrations below 0.2% were used in the next experiments. As shown in FIGS. 2A-C, it was also found that UP at a concentration of 0.1% did not cause any adverse effect on plant development (height, dry weight and root weight), while UP at a concentration of 0.2% significantly inhibited plant development in all the tested parameters. Furthermore, as shown in FIGS. 3A and 3B, the 0.1% UP concentration did not exhibit any adverse effects on plant development in all of the tested parameters, whereby adverse effects were exhibited by the 0.15% UP concentration.

The efficacy of UP in reducing nematode infection and galling severity in tomato plant planted in soil:

The efficacy of 0.1% and 0.2% UP formulations in reducing nematode infection and galling severity in tomato transplants planted in soil was measured, using the protocol described in the method section hereinabove. The results are presented in FIGS. 2A-D. As shown in FIG. 2D, the UP formulations were highly effective in reducing nematode infection and galling severity, as compared with the inoculated non-treated control (denoted CK). In order to further define the efficacy range, additional experiments were conducted using UP formulations at a concentration of 0.15%, 0.1% and 0.075%, using the general protocol described hereinabove. The results are presented in FIGS. 3A-C. As shown in FIG. 3C, the 0.075% UP concentration formulation was less effective in reducing galling index, whereby both the 0.1% and 0.15% UP concentration formulations were found effective in this respect.

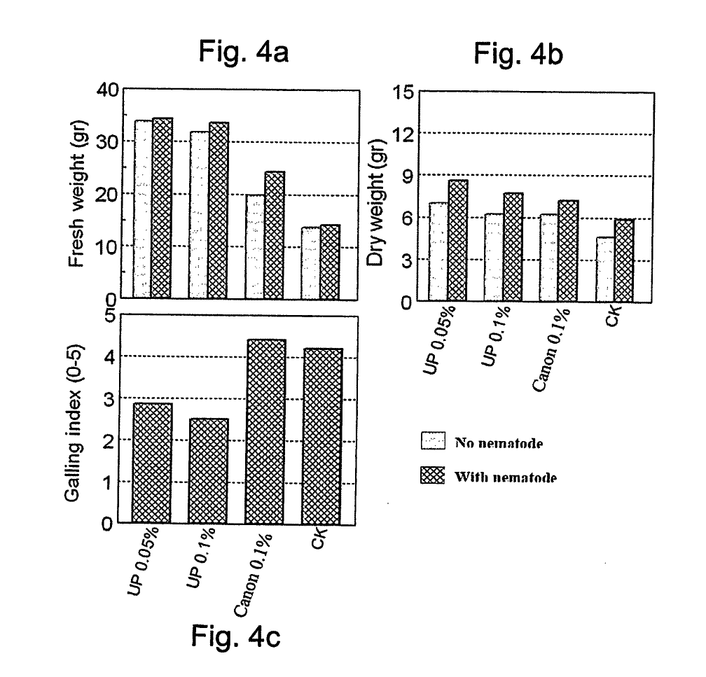

The nematicidal effect of UP formulations at a concentration of 0.05% and 0.1% were further compared with similar concentrations of the commercially available phosphite Canon® 50, and the results are presented in FIGS. 4A-C. As clearly shown in FIG. 4C, the UP formulations at concentrations of 0.05% and 0.1% were more effective in reducing the galling index of tomato plants infected with root-knot nematodes, compared with the commercial phosphorous acid at 0.1%:0.1% UP formulation reduced galling index from 4.3 to 2.5, while the commercial phosphite had a galling index of over 4.3. As clearly shown in FIGS. 4A and 4B, the UP formulations had no adverse effect on plant development (as reflected by the fresh and dry weight thereof), while the commercial phosphite treatment inhibited the fresh weight accumulation of the plants.

The efficacy of UP in reducing nematode infection and galling severity in Hyperikum plants planted in soil and in perlite:

The effect of various concentrations of the UP formulations described herein, compared with that of commercially available phosphite was tested with Hyperikum roots planted either in soil or in artificial substrate (Perlite) using the general protocol described hereinabove. The results are presented in FIG. 5A-5D and again, clearly show that UP, at a rate of 0.05% and 0.1%, was superior to commercially available phosphite formulations in reducing galling index (see, FIGS. 5B and 5D) and exhibited similar effect on the dry weight of the plants (see, FIGS. 5A and 5C). Comparing the results obtained in natural and artificial soil, it is shown that the efficacy of the UP formulations in reducing nematode galling was more pronounced in artificial soil (perlite, FIG. 5D) than in soil (FIG. 5B).

The efficacy of various UP formulations in reducing nematode infection and galling severity in tomato plant planted in soil:

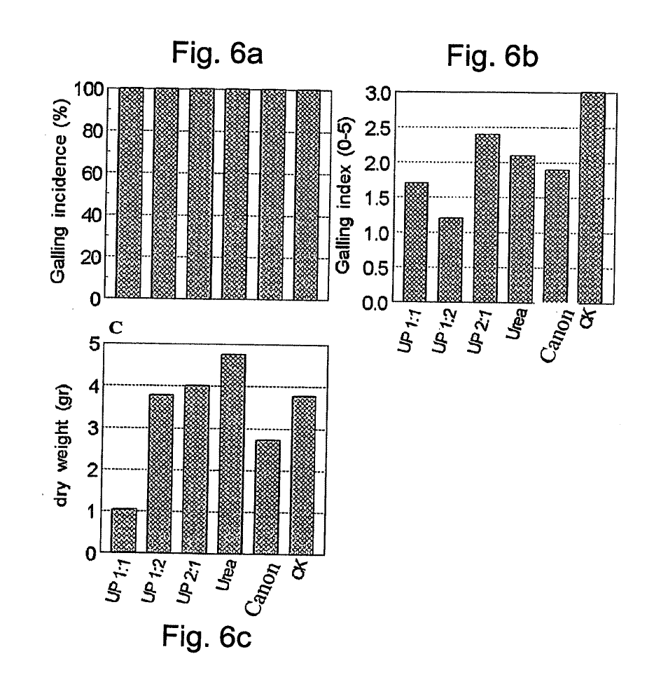

The nematicidal effect of exemplary UP formulations having varying urea and phosphite molar ratios (2:1, 1:1 and 1:2) was compared to that of the single components, and the results are presented in FIGS. 6A-C. As clearly shown in FIGS. 6A and 6B, although a UP formulation at a ratio of 1:2 was better in reducing nematode onset, it has phytotoxic effect, as noticed also in the former experiments with Phosphite at higher rates. Judging the effects of either phosphite or urea alone, it is suggested that the phosphite has higher efficacy in controlling nematodes as compared with urea, whereby urea contributes to plant growth. Overall, these results suggest that the 1:1 mixture is the most effective with regard to all tested parameters, and it was therefore selected for further testing. These results further support the synergistic effect exhibited by each of the UP formulations.

The efficacy of phosphite formulations containing various nitrogen-releasing sources in reducing nematode infection and galling severity in tomato plant planted in soil:

The efficacy of the formulations according to the present invention using various nitrogen-releasing sources was tested and compared with that of an urea-phosphite formulation and of each of the components alone. The phosphite-nitrogen releasing compound molar ratio was 1:1 in each of the tested formulation. The concentration of the active ingredient or composition on each formulation was 0.1%.

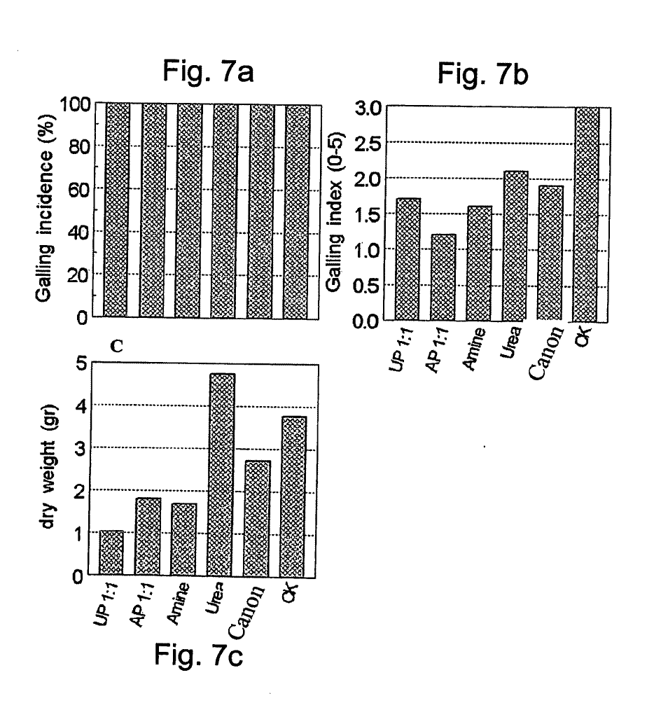

As a first alternative nitrogen-releasing source, tri-ethyl amine was selected. The results obtained in experiments conducted with a UP formulation, an triethylamine-phosphite formulation and urea, phosphite and triethylamine alone are presented in FIGS. 7A-C. As clearly shown in FIGS. 7A-C, although the triethyl amine phosphite formulation was found to be more effective than UP in reducing galling severity, it had a strong phytotoxic effect on plant growth.

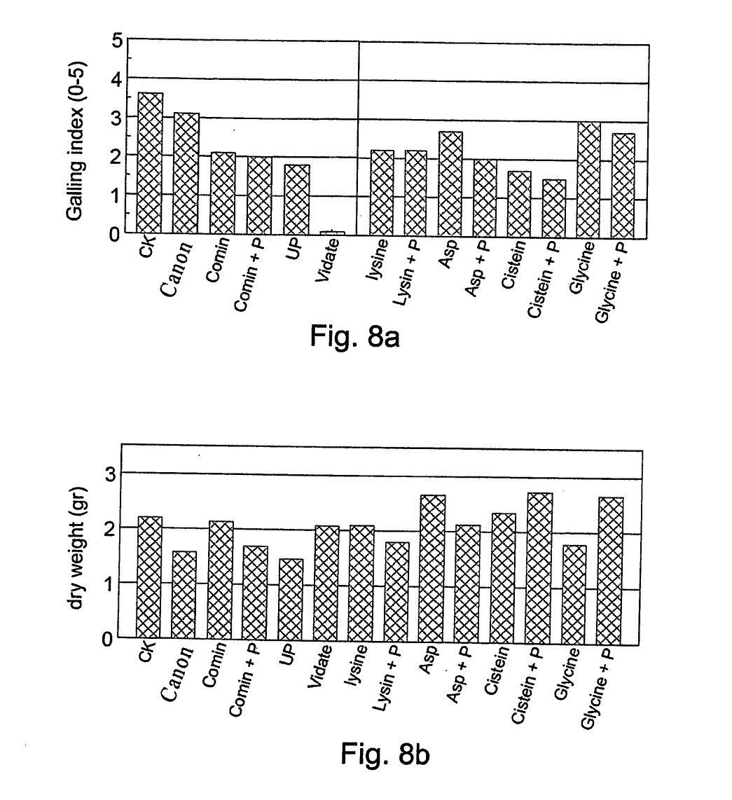

In a different set of experiments various amino acids were tested both alone and combined with phosphites, and the results are presented in FIGS. 8A-B. As is clearly shown in FIGS. 8A and 8B, all the tested amino acid-containing formulations were able to reduce galling infection, with Cysteine, Lysine and Aspartic acid being the most effective. This effect increased with the addition of phosphite. Furthermore, none of the tested amino acid-containing formulations adversely affected the plant growth (reflected by dry weight thereof), thus demonstrating the highly potential nematicidal effect of such formulations.

Field Experiments:

The effect of urea-phosphite application on the galling index and disease index of snap dragon (Antirrhinum majus) roots infected with root-knot nematodes:

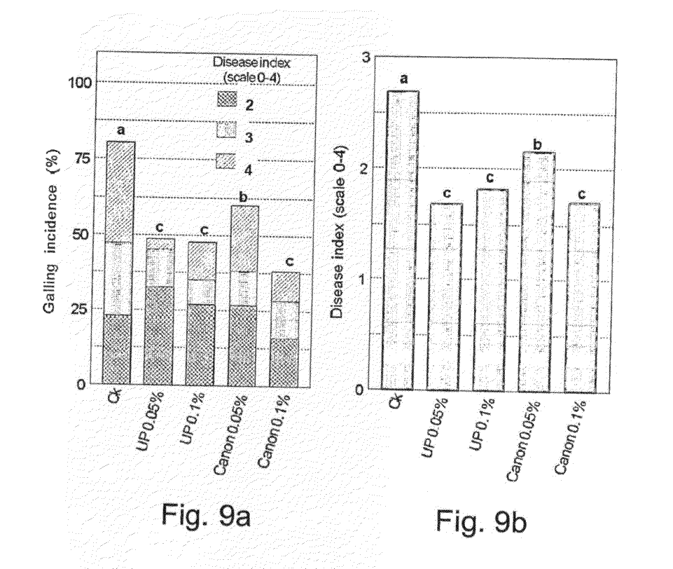

Using the general protocol I described in the methods section hereinabove, the effect of exemplary UP formulations according to the present embodiments, compared with that of Canon® on plant development, disease index and plant growth when applied post-planting to snap dragon plants grown in a nematode-infected open field was tested. The results are presented in FIGS. 9A-9B.

As clearly shown in FIG. 9A, UP formulations at concentrations of 0.05% and 0.1% were effective in reducing galling on plant roots (down to 50%, as compared with 80% galling on the roots on non-treated plants). As shown in FIG. 9B, the effect of the UP formulations was also pronounced in reducing the disease index, and was found to be superior to that of the commercially available Phosphite Canon®. Neither of the tested formulation affected the flower yield or quality (data not shown). In addition, it was found that the UP formulations were also effective in reducing other root diseases (data not shown), whereby the causal agents of these root diseases were not identified.

The effect of urea phosphite post-planting application on the galling index, disease index and growth of snap dragon (antirrhinum majus) roots following pre-plant soil-disinfestation:

A nematode-infected open field was disinfested with various commercial formulations. Snap dragon transplants were thereafter planted and a UP formulation was applied via the irrigation system, as described in detail in general protocol II above. As a control, plots were left untreated or were only treated post-planting with a UP formulation.

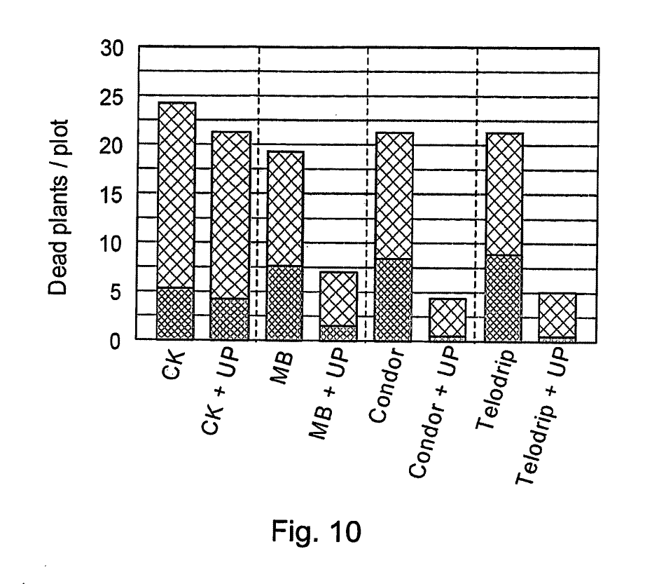

Effect on Damping-off disease: In one month post-planting, collapsing of transplants was observed, with the major pathogen isolated from diseased roots being the soil fungus Rhizoctonia solani. FIG. 10 presents the occurrence of damping-off disease in each plot and clearly shows that post-plant application of a UP formulation significantly reduced the incidence of damping off. The effect of UP in reducing damping-off was much pronounced following soil disinfestation.

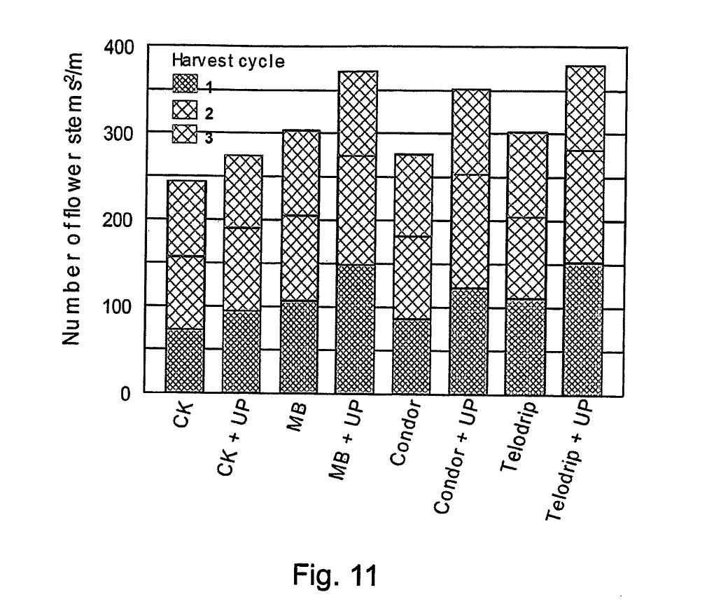

Effect on flower stems: Flower stems were harvested during 3 cycles and were graded according to commercial scale. FIG. 11 presents the number of marketable stems obtained in each of the tested plots and clearly shows a substantial increase in the stem yield in plots treated with the UP formulation. As shown in FIG. 11, soil disinfestation resulted in an increase in the range of 13.1-24%, as compared to the non-disinfested control. Application of UP without soil disinfestation increased the yield by 12.2%. Application of UP on plants grown in disinfested soils further and markedly increased flower yield at a range of 43.8-54.9%. It thus appears that the application of UP had a synergistic effect on increasing yield in disinfested soil. The range of yield increase by soil disinfestation and UP application is also summarized in Table 2 below.

TABLE 2

| | yield increase (%) | | |
|---|---|---|---|
| | | | disinfestation + |
| Treatment | disinfestation | urea-phosphite | urea-phosphite |
| Not disinfested | — | 12.2 | — |
| Methyl Bromide | 24.0 | — | 52.0 |
| Condor ® | 13.1 | — | 43.8 |
| Telodrip ® | 23.7 | — | 54.9 |

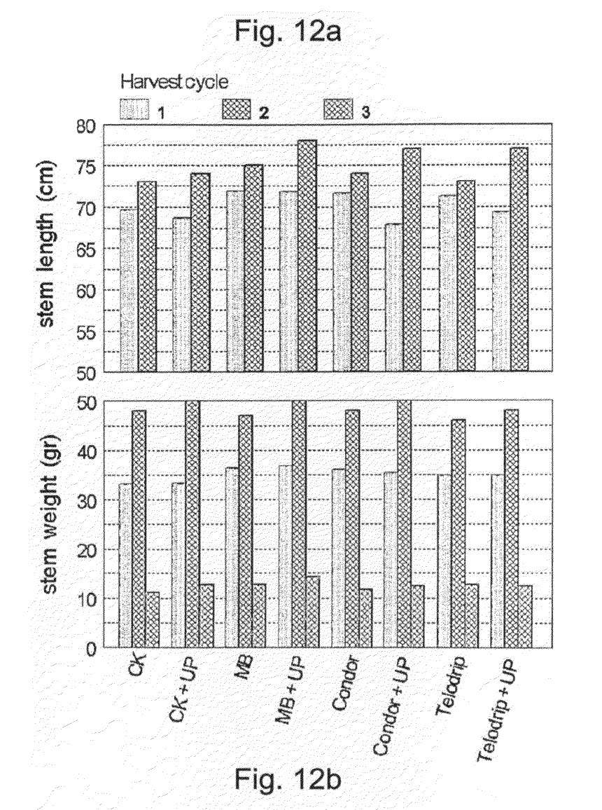

FIGS. 12A and 12B further show the improved flower quality, as expressed by stem length and weight, following UP post-plant application.

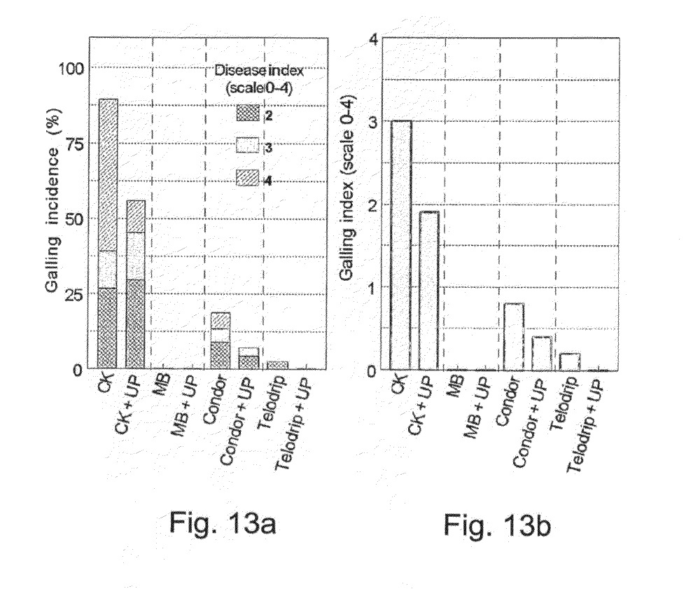

Galling incidence and index: The effect of the UP formulation on the galling incidence and index of roots of snap dragon plants grown in pre-plant disinfested field was tested as described in general protocol II above. The results are presented in FIGS. 13A and 13B and clearly show that although both incidence and severity of nematode infection in the control plots was very high, the application of UP lowered the galling incidence and severity in each of the treated plots (from 84% to 55% in non-infested plots; from 20% to 10% in the phosphorous acid-disinfested plots; and from 4% to approximately 1% in the Telodrip®-disinfested plots).

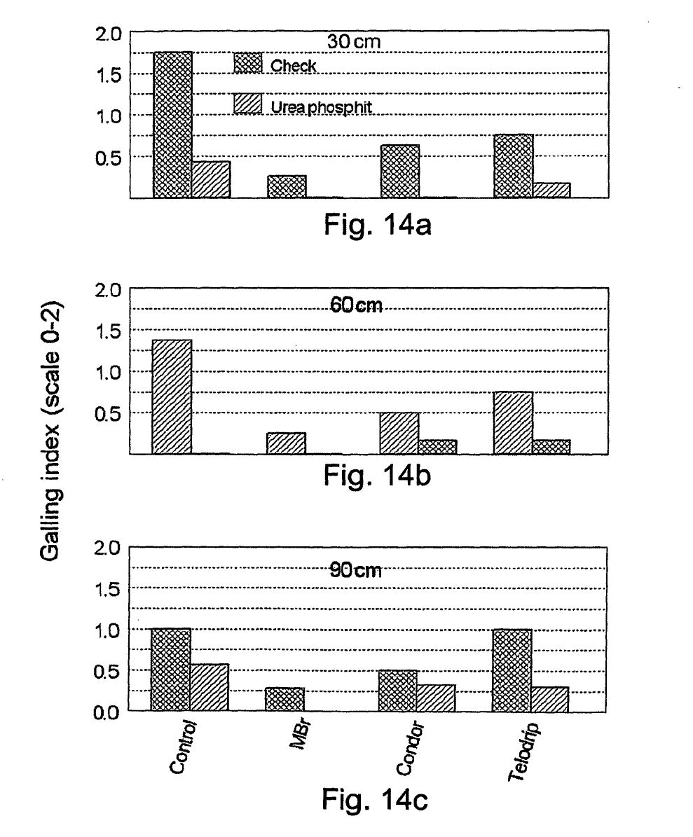

Effect on nematode inoculum: The effect of the UP formulation on nematode inoculum was tested by planting tomato transplants in nematode-infected soil, which was disinfested and post-plant treated with a UP formulation, as detailed hereinabove. The soil was taken from various depths. FIG. 14 presents the galling incidence and severity on tomato roots grown in the various soil samples and clearly shows that while the pre-plant disinfestation reduced the nematodes inoculum in soil compared with the non treated control, application of urea-phosphite further reduced the nematode inoculum (eggs and larvae) in soil. This effect was significant down to a depth of 90 cm. Methyl Bromide and Telodrip® were highly effective in controlling nematode infection in the roots. Application of UP following pre-plant treatment with Condor® substantially improved nematode control. Overall, the contribution of UP in reducing of nematode infection was significant.

The synergistic effect of the combination of a phosphorous-containing compound and a nitrogen-releasing compound was studied and is demonstrated in the effect of phosphorous acid and urea, as an exemplary composition according to the present embodiments on galling index and dry weight, as demonstrated in FIGS. 5, 6 and 7.

Thus, it has been shown in the above studies that the application of urea-phosphite mixtures reduced nematode damage, in terms of infection incidence and severity, both in greenhouse experiments (on tomato transplants) and in field experiments (on snap dragon plants). It has been further shown that the urea-phosphite mixture exhibits nematicidal, activity superior to that of phosphorous acid alone. It has been further shown that the urea-phosphite mixture exhibits a synergistic nematicidal activity compared to that of each of its components alone.

Further, it has been demonstrated that other amines, in particular amino acids, may be combined with phosphite, or with urea-phosphite and serve as nematicidal compositions.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, patent applications mentioned in this specification are herein incorporated in their entirety by reference into the specification, to the same extent as if each individual publication, patent, patent application was specifically and individually indicated to be incorporated herein by reference. In addition, citation or identification of any reference in this application shall not be construed as an admission that such reference is available as prior art to the present invention.

What is claimed is:

1. A pesticide composition comprising at least one phosphorous-containing compound selected from the group consisting of phosphorous acid, a salt thereof, a hydrate thereof and a solvate thereof, and at least one nitrogen-releasing compound.

2. A nematicide composition comprising at least one phosphorous-containing compound selected from the group consisting of phosphorous acid, a salt thereof, a hydrate thereof and a solvate thereof, and at least one nitrogen-releasing compound.

3. The nematicide composition of claim 2, acting by inhibiting a development and/or growth of giant cells of a plant.

4. The composition of claim 2, wherein said nitrogen-releasing compound is other than ammonia.

5. The composition of any of claims 1 to 4, wherein an amount of said at least one phosphorous-containing compound ranges from about 1 weight percentage to about 90 weight percentages of the total weight of the composition.

6. The composition of any of claims 1 to 4, wherein an amount of said at least one phosphorous-containing compound ranges from about 10 weight percentages to about 30 weight percentages of the total weight of the composition.

7. The composition of any of claims 1 to 4, wherein an amount of said at least one nitrogen-releasing compound ranges from about 1 weight percentage and about 90 weight percentages of the total weight of the composition.

8. The composition of any of claims 1 to 4, wherein an amount of said at least one nitrogen-releasing compound ranges from about 10 weight percentage and about 25 weight percentages of the total weight of the composition.

9. The composition of any of claims 1 to 4, wherein a molar ratio between said at least one phosphorous-containing compound and said at least one nitrogen-releasing compound ranges from about 50:1 to about 1:50.

10. The composition of claim 9, wherein said ratio ranges from about 2:1 to about 1:2.

11. The composition of any of claims 1 to 4, wherein said at least one phosphorous-containing compound is selected from the group consisting of H₃PO₃, K₂HPO₃, KH₂PO₃, Na₂HPO₃, NaH₂PO₃ and any mixture thereof.

12. The composition of any of claims 1 to 4, wherein said at least one nitrogen-releasing compound is selected from the group consisting of urea, an amine-containing compound, a derivative thereof, a salt thereof and any mixture thereof.

13. The composition of any of claims 1 to 4, being substantially devoid of an urea condensate.

14. The composition of claim 12, wherein said amine-containing compound comprises at least one amino acid.

15. The composition of claim 14, wherein said at least one amino acid is selected from the group consisting of cysteine, lysine and aspartic acid.

16. The composition of claim 14, wherein said amine-containing compound comprises a peptide.

17. The composition of any of claims 1 to 4, further comprising at least one metal ion.

18. The composition of claim 17, wherein said metal ion is selected from the group consisting of a potassium ion, a copper ion, a zinc ion, a manganese ion, an aluminum ion and any mixture thereof.

19. The composition of claim 17, further comprising at least one chelating agent.

20. The composition of claim 17, wherein an amount of said metal ion ranges from about 1 weight percentage to about 10 weight percentages of the total weight of the composition.

21. The composition of any of claims 1 to 4, comprising:
from about 10 weight percentages to about 30 weight percentages of said phosphorous-containing compound; and
from about 10 weight percentages to about 25 weight percentages of said nitrogen-releasing compound.

22. The composition of claim 21, wherein said nitrogen-releasing compound is urea.

23. The composition of claim 22, wherein said phosphorous-containing compound is H₃PO₃.

24. The composition of any of claims 1 to 4, prepared by mixing said nitrogen-releasing compound and said phosphorous-containing compound at room temperature in the presence of a solvent.

25. The composition of claim 17, prepared by mixing said nitrogen-releasing compound, said phosphorous-containing compound and said at least one metal ion, at room temperature, in the presence of a solvent.

26. The composition of claim 19, prepared by mixing said nitrogen-releasing compound, said phosphorous-containing compound, said at least one metal ion and said at least one chelating agent, at room temperature, in the presence of a solvent.

27. The composition of any of claims 1 to 26, consisting essentially of urea and H₃PO₃.

28. The composition of claim 27, prepared by mixing, at room temperature, an aqueous solution of said urea with said H₃PO₃.

29. The composition of claim 27, being substantially devoid of an urea condensate.

30. The composition of any of claims 1 to 26, capable of inducing systemic resistance in a plant.

31. The composition of any of claims 1 to 26, wherein said at least one phosphorous-containing compound and said at least one nitrogen-releasing compound act in synergy.

32. A pesticide composition comprising at least one phosphorous-containing compound selected from the group consisting of phosphorous acid, a salt thereof, a hydrate thereof and a solvate thereof, and at least one nitrogen-releasing compound, wherein an amount of said at least one phosphorous-containing compound ranges from 10 weight percentage and about 30 weight percentages of the total weight of the composition and an amount of said at least one nitrogen-releasing compounds ranges from 10 weight percentage and about 25 weight percentages of the total weight of the composition.

33. The composition of claim 32, being a nematicide composition.

34. The composition of claim 33, acting by inhibiting a development and/or growth of giant cells of a plant.

35. The composition of claim 32, wherein a molar ratio between said at least one phosphorous-containing compound and said at least one nitrogen-releasing compound ranges from about 50:1 to about 1:50.

36. The composition of claim 35, wherein said ratio ranges from about 2:1 to about 1:2.

37. The composition of claim 32, wherein said at least one phosphorous-containing compound is selected from the group consisting of H₃PO₃, K₂HPO₃, KH₂PO₃, Na₂HPO₃, NaH₂PO₃ and any mixture thereof.

38. The composition of claim 32, wherein said at least one nitrogen-releasing compound is selected from the group consisting of urea, an amine-containing compound, a derivative thereof, a salt thereof and any mixture thereof.

39. The composition of claim 38, wherein said amine-containing compound comprises at least one amino acid.

40. The composition of claim 39, wherein said at least one amino acid is selected from the group consisting of cysteine, lysine and aspartic acid.

41. The composition of claim 39, wherein said amine-containing compound comprises a peptide.

42. The composition of claim 32, further comprising at least one metal ion.

43. The composition of claim 42, wherein said metal ion is selected from the group consisting of a potassium ion, a copper ion, a zinc ion, a manganese ion, an aluminum ion and any mixture thereof.

44. The composition of claim 42, further comprising at least one chelating agent.

45. The composition of claim 42, wherein an amount of said metal ion ranges from about 1 weight percentage to about 10 weight percentages of the total weight of the composition.

46. The composition of claim 32, wherein said nitrogen-releasing compound is urea.

47. The composition of claim 32, wherein said phosphorous-containing compound is H₃PO₃.

48. The composition of claim 32, prepared by mixing said nitrogen-releasing compound and said phosphorous-containing compound at room temperature in the presence of a solvent.

49. The composition of claim 42, prepared by mixing said nitrogen-releasing compound, said phosphorous-containing compound and said at least one metal ion, at room temperature in the presence of a solvent.

50. The composition of claim 44, prepared by mixing said nitrogen-releasing compound, said phosphorous-containing compound, said at least one metal ion and said at least one chelating agent, at room temperature, in the presence of a solvent.

51. The composition of any of claims 32 to 50, consisting essentially of urea and H₃PO₃.

52. The composition of claim 51, prepared by mixing, at room temperature, an aqueous solution of said urea with said H₃PO₃.

53. The composition of claim 51, being substantially devoid of an urea condensate.

54. The composition of any of claims 32 to 53, capable of inducing systemic resistance in a plant.

55. The composition of any of claims 32 to 53, wherein said at least one phosphorous-containing compound and said at least one nitrogen-releasing compound act in synergy.

56. A pesticide formulation comprising the composition of any of claims 1 to 55 and a carrier.

57. The formulation of claim 56, wherein said carrier is selected from the group consisting of an aqueous carrier, an organic carrier and any combination thereof.

58. The formulation of claim 56, further comprising at least one agent selected from the group consisting of a protective colloid, an acidifying agent, an adhesive, a thickening agent, a penetrating agent, a stabilizing agent, a sequestering agent, a fertilizer, an anti-freeze agent, a repellent, a color additive, a corrosion inhibitor, a water-repelling agent, a siccative, a UV-stabilizer, a pigment, a dye and a polymer.

59. The formulation of claim 56, wherein a concentration of said composition ranges from about 0.001 weight percentage to about 1 weight percentage of the total weight of the formulation.

60. The formulation of claim 56, wherein a concentration of said composition ranges from about 0.05 weight percentage to about 0.2 weight percentage of the total weight of the formulation.

61. The formulation of claim 56, being in a form of a solid, a powder, a solution, a dispersion, a suspension, a paste, an aerosol or a spray.

62. The formulation of claim 56, being packaged in a packaging material and identified in print, in or on said packaging material, for use in controlling pests.

63. The formulation of claim 62, wherein said pests are selected from the group consisting of nematodes, fungi and bacteria.

64. The formulation of claim 62, wherein controlling said pests comprises inducing a systemic resistance in a plant.

65. The formulation of claim 63, wherein said pests are nematodes and controlling said pests comprises inhibiting a development and/or growth of giant cells in a plant.

66. The formulation of claim 56, further comprising at least one pesticide.

67. A method of controlling pests, the method comprising contacting a substance, a product or a structure with a pesticidal effective amount of the composition of any of claims 1 to 55.

68. The method of claim 67, wherein said pests are selected from the group consisting of nematodes, fungi and bacteria.

69. The method of claim 67, wherein controlling said pests comprises inducing a systemic resistance in a plant.

70. The method of claim 67, wherein said pests are nematodes and controlling said pests comprises inhibiting a development and/or growth of giant cells in a plant.

71. The method of claim 67, wherein said substance is a soil.

72. The method of claim 67, wherein said contacting is effected by spraying, drenching, soaking, dipping, mixing, coating, dispersing, injecting, irrigating or impregnating.

73. The method of claim 67, further comprising, prior to, concomitant with or subsequent to said contacting: disinfecting said substance, product or structure.

74. The method of claim 73, wherein said disinfecting is performed prior to said contacting.

75. The method of claim 67, wherein said composition forms a part of a pesticide formulation, said formulation further comprising a carrier.

76. The method of claim 75, wherein said formulation is applied at an application rate that ranges from about 1 liter/1000 m² to about 100 liters/1000 m².

77. The method of claim 76, wherein said application rate ranges from about 1 liter/1000 m² to about 5 liters/1000 m².

78. An article-of-manufacture comprising a packaging material and the composition of any of claims 1 to 55 being packaged in said packaging material, said article-of-manufacture being identified for use in controlling pests.

79. The article-of-manufacture of claim 78, wherein said composition forms a part of pesticide formulation, said formulation further comprising a carrier.

80. The article-of-manufacture of claim 79, wherein said carrier is selected from the group consisting of an aqueous carrier, an organic carrier and any combination thereof.

81. The article-of-manufacture of claim 79, wherein a concentration of said composition ranges from about 0.001 weight percentage to about 1 weight percentage of the total weight of said formulation.

82. The article-of-manufacture of claim 79, wherein a concentration of said composition ranges from about 0.05 weight percentage to about 0.2 weight percentage of the total weight of said formulation.

83. The article-of-manufacture of claim 79, wherein said formulation is in a form of a solid, a powder, a solution, a dispersion, a suspension, a paste, an aerosol or a spray.

84. The article-of-manufacture of claim 78, wherein said pests are selected from the group consisting of nematodes, fungi and bacteria.

85. The article-of-manufacture of claim 78, wherein controlling said pests comprises inducing a systemic resistance in a plant.

86. The article-of-manufacture of claim 78, wherein said pests are nematodes and controlling said pests comprises inhibiting a development and/or growth of giant cells in a plant.

87. A process of preparing the pesticide composition of any of claims 1 to 55, the process comprising mixing said phosphorous-containing compound and said nitrogen-releasing compound.

88. The process of claim 87, wherein said composition further comprises at least one metal ion, and the process comprising:
mixing said phosphorous-containing compound, said nitrogen-releasing compound and said at least one metal ion.

89. The process of claim 88, wherein said composition further comprises at least one chelating agent, the process comprising:
mixing said phosphorous-containing compound, said nitrogen-releasing compound, said at least one metal ion and said at least one chelating agent.

90. The process of any of claims 87 to 89, wherein said mixing is effected in the presence of a solvent.

91. The process of claim 90, wherein said solvent is water.

92. The process of any of claims 87 to 89, wherein said mixing is performed at room temperature.
